(19) United States
(12) Patent Application Publication
(10) Pub. No.: US 2013/0042202 A1
(43) Pub. Date: Feb. 14, 2013

(54) MOBILE TERMINAL DEVICE, STORAGE MEDIUM AND LOCK CACELLATION METHOD

(71) Applicants: Keiko Mikami, Daito-shi (JP); Toshihiro Kamii, Daito-shi (JP)

(72) Inventors: Keiko Mikami, Daito-shi (JP); Toshihiro Kamii, Daito-shi (JP)

(73) Assignee: KYOCERA CORPORATION, Kyoto (JP)

(21) Appl. No.: 13/643,832

(22) PCT Filed: Feb. 24, 2012
(86) PCT No.: PCT/JP2012/054621

§ 371 Date: Oct. 26, 2012

(30) Foreign Application Priority Data
Mar. 11, 2011 (JP) 2011-054687

(51) Int. Cl. G06F 3/048; G06F 3/041

(52) U.S. Cl. 715/781

(57) ABSTRACT

A CPU displays on display surfaces a cancel screen for cancelling the key lock function, and moves an object image depending on movement of a touch position when the object image contained in the cancel screen is touched by the user and the touch position is moved. Furthermore, the CPU sets a cancel area of the key lock function on the cancel screen so that a direction in which the object image is moved to cancel the key lock function is not limited to one direction, and cancels the key lock function when the touch position to the object image is moved to the cancel area.

### TECHNICAL FIELD

The present invention relates to a mobile terminal device such as a cellular phone or a PDA (Personal Digital Assistant), and a program and a lock cancellation method preferred to be used in a mobile terminal device.

### BACKGROUND ART

Conventionally, a mobile terminal device has a key lock function for disabling an input to a key button or a touch panel. If such a key lock function is set in a mobile terminal device, a user can use the mobile terminal device after cancelling the key lock function.

In such a mobile terminal device, when a set key button continues to be pressed for more than a set time, the key lock function is cancelled.

### SUMMARY OF INVENTION

### Technical Problem

In the configuration described above, it is possible that an object keeps on touching a set key button when a mobile terminal device is placed in a bag. In such a case, a key lock function may be easily cancelled without a user's intention.

The present invention has been made in view of such a problem, and an object of the present invention is to provide a mobile terminal device, a program, and a lock cancellation method which make it less likely that a key lock function is cancelled against a user's intention.

### Solution to Problem

A mobile terminal device according to a first aspect of the present invention includes a display section with a display surface on which an image is displayed, a detection section which detects a touch input to the display surface, a display control section which controls the display section, and a function control section which controls cancellation of a key lock function that disables a predetermined touch input to the display surface. Here, the display control section displays on the display surface a cancel screen for cancelling the key lock function, and moves an object image depending on movement of a touch position when the object image contained in the cancel screen is touched by a user and the touch position is moved. The function control section sets a cancel area of the key lock function on the cancel screen so that a direction in which the object image is moved to cancel the key lock function is not limited to one direction, and cancels the key lock function when the touch position to the object image is moved to the cancel area.

A program according to a second aspect of the present invention provides a computer of a mobile terminal device including a display section with a display surface on which an image is displayed and a detection section which detects a touch input to the display surface, with capabilities of displaying on the display surface a cancel screen for cancelling a key lock function which disables a predetermined touch input to the display surface, and moving an object image depending on movement of a touch position when the object image contained in the cancel screen is touched by a user and the touch position is moved; and of setting a cancel area of the key lock function on the cancel screen so that a direction in which the object image is moved to cancel the key lock function is not limited to one direction, and cancelling the key lock function when the touch position to the object image is moved to the cancel area.

A third aspect of the present invention relates to a lock cancellation method of a mobile terminal device including a display section with a display surface on which an image is displayed and a detection section which detects a touch input to the display surface. The lock cancellation method according to the third aspect includes steps of displaying on the display surface a cancel screen for cancelling a key lock function which disables a predetermined touch input to the display surface; moving an object image depending on movement of a touch position when the object image contained in the cancel screen is touched by a user and the touch position is moved; and cancelling the key lock function when the touch position to the object image is moved to the cancel area which is set on the cancel screen so that a direction in which the object image is moved to cancel the key lock function is not limited to one direction.

### Advantageous Effects of Invention

According to the present invention, a mobile terminal device which makes it less likely that a key lock function is cancelled against a user's intention can be provided.

An advantage or significance of the present invention will become clearer from the description of embodiment, as shown below. However, the following description of embodiment is simply one illustration in embodying the present invention, and the present invention is not limited by what is described in the following description of embodiment.

### BRIEF DESCRIPTION OF DRAWINGS

FIG. 1 is a diagram showing an appearance configuration of a cellular phone according to an embodiment.

FIGS. 2(a) to 2(d) are diagrams showing switching of a state of the cellular phone according to the embodiment.

FIG. 3 is a block diagram showing an overall configuration of the cellular phone according to the embodiment.

FIGS. 4(a) and 4(b) are diagrams in which a cancel screen is displayed on display surfaces according to the embodiment.

FIG. 5 is a diagram in which the cancel screen is displayed on the display surfaces according to the embodiment.

FIG. 6 is a flow chart showing a procedure for processing to cancel a key lock function by execution of an operation of moving a display position of an object image to a cancel area according to the embodiment.

FIG. 7 is a flow chart showing a procedure for processing to cancel the key lock function if the display position of the object image at the time of release is in the cancel area according to the embodiment.

FIG. 8 is a flow chart showing a procedure for processing to cancel the key lock function if the display position of the object image is in the cancel area for more than predetermined length of time according to the embodiment.

FIG. 9 is a flow chart showing a procedure for processing to cancel the key lock function if the display position of the object image is at a same position in the cancel area for more than predetermined length of time according to the embodiment.

FIGS. 10(a) and 10(b) are diagrams in which the cancel screen is displayed in the display surfaces according to the embodiment.

FIGS. 11(a) and 11(b) are diagrams in which the cancel screen is displayed in the display surfaces according to the embodiment.

FIG. 12 is a diagram in which the cancel screen is displayed in the display surfaces according to the embodiment.

FIGS. 13(a) to 13(c) are diagrams in which the cancel screen is displayed on a first display surface in a closed state according to the embodiment.

FIGS. 14(a) and 14(b) are diagrams in which the cancel screen is displayed in the display surfaces in an open state according to the embodiment.

FIG. 15 is a diagram for illustrating a configuration example for cancelling the key lock function with the cellular phone closed according to the embodiment.

FIG. 16 is a diagram for illustrating a configuration example for cancelling the key lock function with the cellular phone closed according to the embodiment.

FIGS. 17(a) and 17(b) are diagrams for illustrating a configuration example for cancelling the key lock function with the cellular phone closed according to the embodiment.

FIG. 18 is a diagram for illustrating a modification example of a configuration for cancelling the key lock function with the cellular phone closed according to the embodiment.

FIG. 19 is a diagram for illustrating a modification example of a configuration for cancelling the key lock function with the cellular phone closed according to the embodiment.

FIGS. 20(a) and 20(b) are diagrams for illustrating a modification example of a configuration for cancelling the key lock function with the cellular phone closed according to the embodiment.

FIGS. 21 (a) to 21(c) are diagrams for illustrating a further modification example of a configuration for cancelling the key lock function with the cellular phone closed according to the embodiment.

The drawings are mainly used for a description of one example of the embodiment, however, and not intended to limit a scope of the present invention.

### DESCRIPTION OF EMBODIMENTS

In the following, embodiments of the present invention will be described with reference to the drawings.

### <Configuration of Cellular Phone>

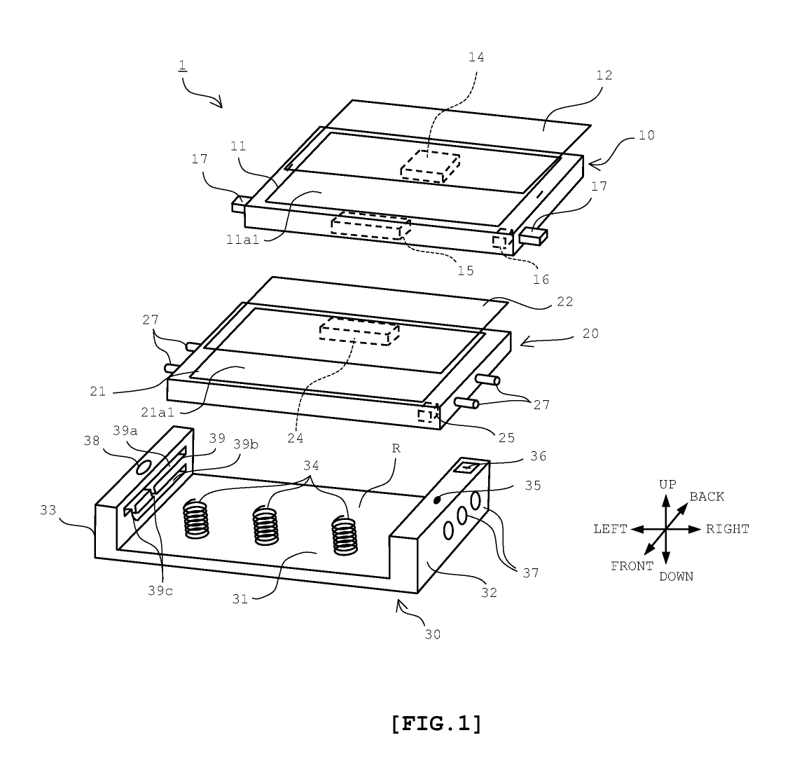

FIG. 1 is an exploded perspective view showing a configuration of a cellular phone 1. The cellular phone 1 is composed of a first cabinet 10, a second cabinet 20, and a holder 30 which holds the first cabinet 10 and the second cabinet 20.

The first cabinet 10 has a horizontally long rectangular solid shape. A first touch panel is arranged on a front face of the first cabinet 10. The first touch panel includes a first display 11 and a first touch sensor 12.

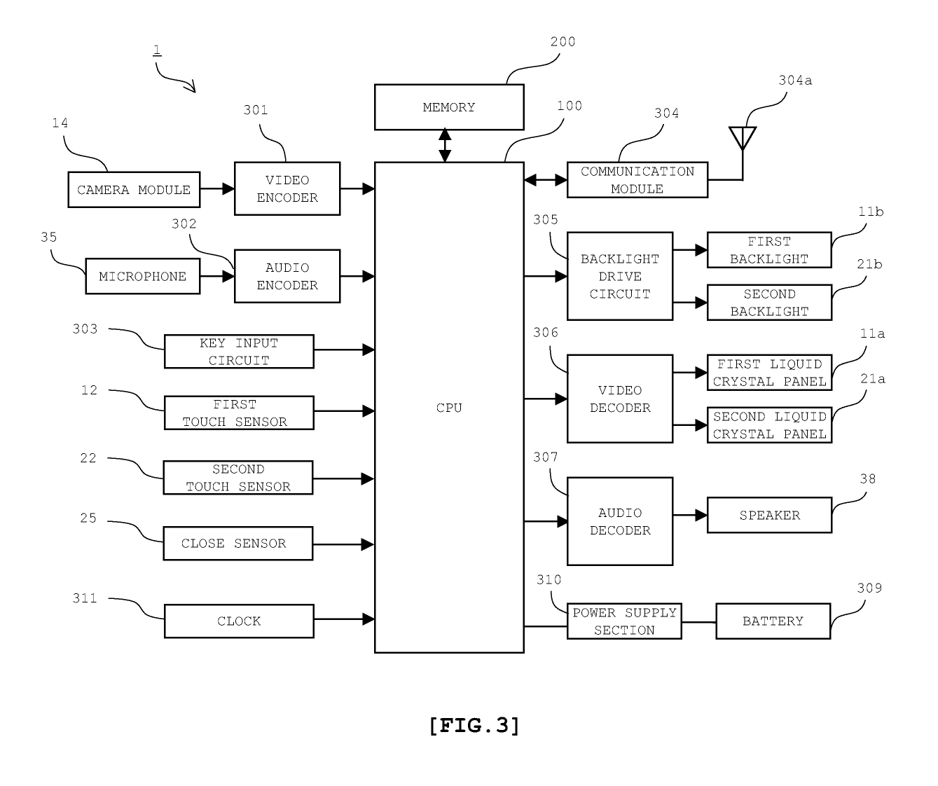

The first display 11 corresponds to a display section which displays an image on a first display surface 11a1. The first display 11 is composed of a first liquid crystal panel 11a and a first backlight 11b (See FIG. 3). The first display surface 11a1 is provided on a front face of the first liquid crystal panel 11a. The first touch sensor 12 overlies the first display surface 11a1. The first backlight 11b includes one or more light sources and illuminates the first liquid crystal panel 11a.

The first touch sensor 12 corresponds to a detection section which detects an input to the first display 11. The first touch sensor 12 is a transparent rectangle shaped sheet and covers the first display surface 11a1 of the first display 11. The first touch sensor 12 includes a matrix-like arranged first transparent electrode and a second transparent electrode. By detecting a change in capacitance between the transparent electrodes, the first touch sensor 12 detects a position on the first display surface 11a1 touched by a user, and outputs a position signal corresponding to the input position. The user touching on the first display surface 11a1 is the user touching the first display surface 11a1 with a contact member such as a pen or a finger, for example. The user may rest or move the contact member or the finger which touched the first display surface 11a1. In addition, length of time for which the contact member or the finger is in touch with the first display surface 11a1 may be short or long.

In the first cabinet 10, a camera module 14 is arranged at a position slightly back of a center. A lens window (not shown) for capturing a subject image in the camera module 14 is provided on an underside of the first cabinet 10.

In addition, in the first cabinet 10, a magnet 15 is arranged at a center position in the vicinity of the front face and a magnet 16 is arranged at the right front corner.

Protruding portions 17 are provided on the right and left sides of the first cabinet 10.

The second cabinet 20 has a horizontally long rectangular solid shape and has almost the same shape and size as those of the first cabinet 10. A second touch panel is arranged on the second cabinet 20. The second touch panel includes a second display 21 and a second touch sensor 22.

The second cabinet 20 corresponds to a display section which displays an image on a second display surface 21a1. The second display 21 is composed of a second liquid crystal panel 21a and a second backlight 21b (See FIG. 3). The second display surface 21a1 is provided on a front face of the second liquid crystal panel 21a. The second backlight 21b includes one or more light sources and illuminates the second liquid crystal panel 21a. The first display 11 and the second display 21 are composed of other display elements such as organic electroluminescence (EL).

The second touch sensor 22 corresponds to a detection section which detects an input to the second display 21. The second touch sensor 22 has almost the same shape and configuration as those of the first touch sensor 12. The second touch sensor 22 covers the second display surface 21a1 of the second display 21, detects a position on the second display surface 21a1 touched by the user, and outputs a position signal corresponding to the input position.

In the second cabinet 20, a magnet 24 is arranged at a center position in the vicinity of a rear face. The magnet 24 and the magnet 15 of the first cabinet 10 attract each other in an open state to be described later.

In the second cabinet 20, a close sensor 25 is arranged at the right front corner. The close sensor 25 is composed of a hall IC and the like, for example. When the close sensor 25 detects magnetic force of the magnet 16, the close sensor 25 outputs a sensor signal. In a closed state to be described later, since the magnet 16 of the first cabinet 10 is in proximity to the close sensor 25, a sensor signal is output from the close sensor 25 to a CPU 100. In contrast, when the state changes from closed to open, the magnet 16 of the first cabinet 10 becomes away from the close sensor 25. Thus, the close sensor 25 does not output a sensor signal.

Two respective shaft portions 27 are provided on both sides of the second cabinet 20.

The holder 30 is composed of a bottom plate portion 31, a right holding portion 32 formed on a right edge part of the bottom plate portion 31, and a left holding portion 33 formed on a left edge part of the bottom plate portion 31.

Three coil springs 34 are arranged on the bottom plate portion 31 so that the coil springs 34 line in a horizontal direction. With the second cabinet 20 attached to the holder 30, the coil springs 34 abut an underside of the second cabinet 20 and exhibit force to push up the second cabinet 20.

On an upper surface of the right holding portion 32, a microphone 35 and a power supply key 36 are arranged. A speaker 38 is arranged on an upper surface of the left holding portion 33. A plurality of hard keys 37 are arranged on an outer surface of the right holding portion 32.

On inner sides of the right holding portion 32 and the left holding portion 33, guiding grooves 39 (only that on the left holding portion 33 is shown) are formed. The guiding grooves 39 are composed of an upper groove 39a, a lower groove 39b, and two vertical grooves 39c. The upper groove 39a and the lower groove 39b extend in a forward-backward direction, and the vertical grooves 39c extend upward and downward so as to connect the upper groove 39a and the lower groove 39b.

When the cellular phone 1 is assembled, the shaft portions 27 are inserted into the lower groove 39b of the guiding grooves 39, and the second cabinet 20 is arranged in a containing region R of the holder 30. The protruding portions 17 are inserted into the upper groove 39a of the guiding grooves 39, and the first cabinet 10 is fitted in the containing region R of the holder 30. The first cabinet 10 is arranged on the second cabinet 20.

In this manner, the first cabinet 10 and the second cabinet 20 are contained in a vertically overlapped state into the containing region R surrounded by the bottom plate portion 31, the right holding portion 32, and the left holding portion 33. In this state, the first cabinet 10 is slidable forward and backward along the upper groove 39a. The second cabinet 20 is slidable forward and backward along the lower groove 39b. In addition, when the second cabinet 20 moves forward and the shaft portions 27 reach the position of the vertical groove 39c, the second cabinet 20 becomes vertically slidable along the vertical groove 39c.

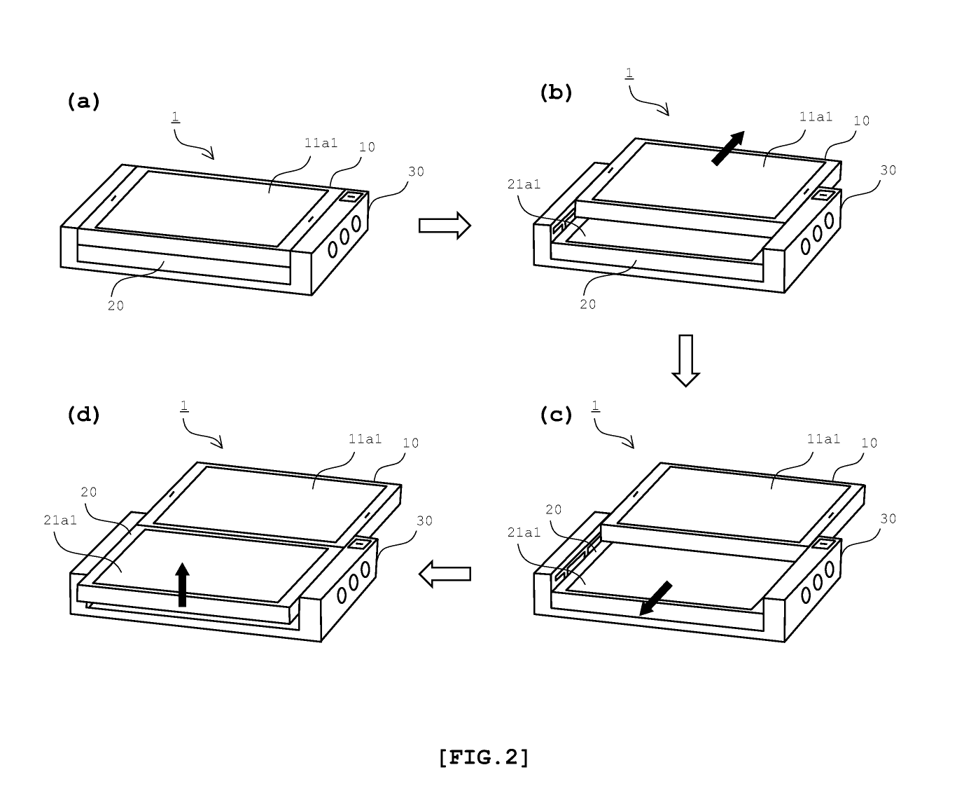

FIGS. 2(a) to 2(d) are diagrams for illustrating how the cellular phone 1 is switched from a closed state to an open state.

The closed state shown in FIG. 2(a) is a state in which the cellular phone 1 is folded. In the closed state, the first cabinet 10 is folded over the second cabinet 20. The closed state corresponds to a first form in which the first cabinet 10 masks the second display surface 21a1. In the closed state, only the first display surface 11a1 is exposed to the external.

As shown in FIG. 2 (b), the first cabinet 10 is moved backward, and as shown in FIG. 2(c), the second cabinet 20 is moved forward. With this, the close sensor 25 does not detect the magnetic force of the magnet 16 and no longer outputs a sensor signal. Then, the cellular phone 1 is switched to an open state. In the open state, a part of the second display surface 21a1 appears outside.

When the second cabinet 20 does not overlie the first cabinet 10, the shaft portions 27 enter the vertical groove 39c. Then, since the shaft portions 27 becomes movable along the vertical groove 39c, the second cabinet 20 can move up and down. Then, the second cabinet 20 rises due to elastic force of the coil springs 34 and attraction between the magnet 15 and the magnet 24.

As shown in FIG. 2(d), the second cabinet 20 is closely juxtaposed to the first cabinet 10, and the second display surface 21a1 becomes flush with the first display surface 11a1. This unfolds the first cabinet 10 and the second cabinet 20, exposing the first display surface 11a1 and the second display surface 21a1 to the external.

As shown in FIG. 2(b) to FIG. 2(d), the open state corresponds to a second form in which at least a part of the second display surface 21a1 is exposed to the external.

In addition, the closed state and the open state can be switched by the protruding portion 17 moving on the upper groove 39a of the guiding groove 39 of the guiding groove 39 and the shaft portion 27 moving on the lower groove 39b, the vertical groove 39c, and the upper groove 39a. Thus, the protruding portions 17, the shaft portions 27, and the guiding grooves 39 correspond to a switching section which can switch the closed state and the open state.

FIG. 3 is a block diagram showing an overall configuration of the cellular phone 1. In addition to the components described above, the cellular phone 1 of the embodiment includes a CPU 100, a memory 200, a video encoder 301, an audio encoder 302, a key input circuit 303, a communication module 304, a backlight drive circuit 305, a video decoder 306, an audio decoder 307, a battery 309, a power supply section 310, and a clock 311.

The camera module 14 has an image pickup device such as CCD. The camera module 14 digitalizes an imaging signal output from the image pickup device, subjects the imaging signal to various corrections such as gamma correction, and outputs the imaging signal to the video encoder 301. The video encoder 301 encodes the imaging signal from the camera module 14 and outputs the imaging signal to the CPU 100.

The microphone 35 converts collected sound into an audio signal and outputs the audio signal to the audio encoder 302. The audio encoder 302 not only converts the analog audio signal from the microphone 35 into a digital audio signal, but also encodes and outputs the audio signal to the CPU 100.

When each key such as the power supply key 36 or the hard key 37 is pressed, the key input circuit 303 outputs an input signal corresponding to the each key to the CPU 100.

The communication module 304 converts data from the CPU 100 into a radio signal and transmits the radio signal to a base station via an antenna 304a. In addition, the communication module 304 converts a radio signal received via the antenna 304a into data and outputs the data to the CPU 100.

The backlight drive circuit 305 supplies to the first backlight 11b and the second backlight 21b a drive signal based on a control signal from the CPU 100. The first backlight 11b turns on by a drive signal from the backlight drive circuit 305 and illuminates the first liquid crystal panel 11a. The second backlight 21b turns on by a drive signal from the backlight drive circuit 305, and illuminates the second liquid crystal panel 21a.

The video decoder 306 converts image data from the CPU 100 into image signals which can be displayed on the first liquid crystal panel 11a and the second liquid crystal panel 21a, and outputs the image signals to the liquid crystal panels 11a and 21a. The first liquid crystal panel 11a displays a first image corresponding to the image signal on the first display surface 11a1. The second liquid crystal panel 21a displays a second image corresponding to the image signal on the second display surface 21a1.

The audio decoder 307 decodes an audio signal from the CPU 100 or a tone signal of various notifying sounds such as a ring tone or alarm sound from the CPU 100, further converts the audio signal or the tone signal into the analog audio signal, and outputs the analog audio signal to the speaker 38. The speaker 38 reproduces the tone signal or the audio signal from the audio decoder 307.

The battery 309 supplies electric power to the CPU 100 and each section other than the CPU 100. The battery 309 is connected to the power supply section 310.

The power supply section 310 converts voltage of the battery 309 to the amount of voltage necessary for each section and supplies the voltage to each section. In addition, the power supply section 310 supplies electric power fed via an external power supply (not shown) to the battery 309 to charge the battery 309.

The clock 311 measures length of time and outputs to the CPU 100 a signal corresponding to the measured length of time.

The memory 200 includes ROM and RAM.

A control program for providing the CPU 100 with a control function is stored in the memory 200. Such a control program includes a control program for cancelling the key lock function when an input to move a display position P of an object image OI to a cancel area RA which is a predetermined distance, 320 px for example, away from a starting position P0 is detected.

Data of images taken with the camera module 14, data captured from the external via the communication module 304, and data inputted from the touch sensors 12 and 22 are saved in a predetermined file format in the memory 200. Image data of a screen for cancelling the key lock function, to be described later (hereinafter referred to as a “cancel screen”) is stored in the memory 200. In addition, the starting position P0 of the object image OI to be contained in the cancel screen is also stored in the memory 200.

The memory 200 stores a common display coordinate system and an individual display coordinate system. In the individual display coordinate system, a display coordinate system of the first display surface 11a1 and a display coordinate system of the second display surface 21a1 are provided individually. In the common display coordinate system, the first display surface 11a1 and the second display surface 21a1 have a common display coordinate system, and a coordinate axis X of the first display surface 11a1 continues into a coordinate axis X of the second display surface 21a1.

The memory 200 stores information of association of operation amount and travel distance. In the information of association of operation amount and travel distance, the operation amount performed by a user flicking before release is associated with a travel distance of the object image OI after the release. The operation amount by the user refers to a speed at which an input position moves when the user flicks on the object image OI displayed on the display surface 11a1 or 21a1, with his/her finger and the like and before the user releases his/her finger and the like from the object image OI (hereinafter referred to as a “travel speed of the input position”). The travel distance of the object image OI on the cancel screen refers to a speed and distance C at/for which the object image OI moves after the release.

After the user touches the object image OI and the input position matches the starting position P0 of the object image OI, the input position is obtained for every predetermined length of time. The input position is temporarily stored in the memory 200. Thus, the input position before release is read from the memory after the release, and a travel speed of the input position before the release is determined from the input position for every predetermined length of time.

The information of association of operation amount and travel distance may be a table in which a travel speed of the input position is associated with a travel speed of the object image OI and travel distance C. In addition, the information of association of operation amount and the travel distance may be an arithmetic expression for calculating the travel speed and travel distance C of the object image OI from the travel speed of the input position.

Furthermore, in the information on association of operation amount and travel distance, it is set that the faster a travel speed of the input position is, the faster and for the longer distance an object image OI moves. With this, the faster the user moves his/her finger touching the display surfaces 11a1 and 12a1, the longer distance the object image OI moves.

Based on an operation input signal from the key input circuit 303 and the touch sensors 12, 22, the CPU 100 operates the camera module 14, the microphone 35, the communication module 304, the liquid crystal panels 11a, 21a, the speaker 38, the speaker 38 and the like in accordance with the control program. With this, the CPU 100 runs various applications such as a telephone call function, an e-mail function, a power saving function, a key lock function.

As the display control section, the CPU 100 outputs a control signal to the video decoder 306 and the backlight drive circuit 305. For example, the CPU 100 controls the backlight drive circuit 305, and turns off the backlights 11b and 21b. On the one and, the CPU 100 not only turns on the backlights 11b and 21b, but also controls the video decoder 306, and displays an image on the display surfaces 11a1 and 21a1. The CPU 100 controls contrast, brightness, screen size, and transparency of a screen and the like when an image is displayed on the display surfaces 11a1 and 21a1.

For example, if the key lock function is set, the CPU 100 reads image data of the cancel screen from the memory 200 and displays the cancel screen on the first and second display surfaces 11a1 and 21a1. If the display surfaces 11a1 and 21a1 is touched or the hard key 37 is pressed while the backlights 11b and 21b is turned off after the key lock function is set, the cancel screen appears. In addition, when the cancel screen is displayed, the common display coordinate system is read from the memory 200 and control is performed by the CPU 100 based on the common display coordinate system.

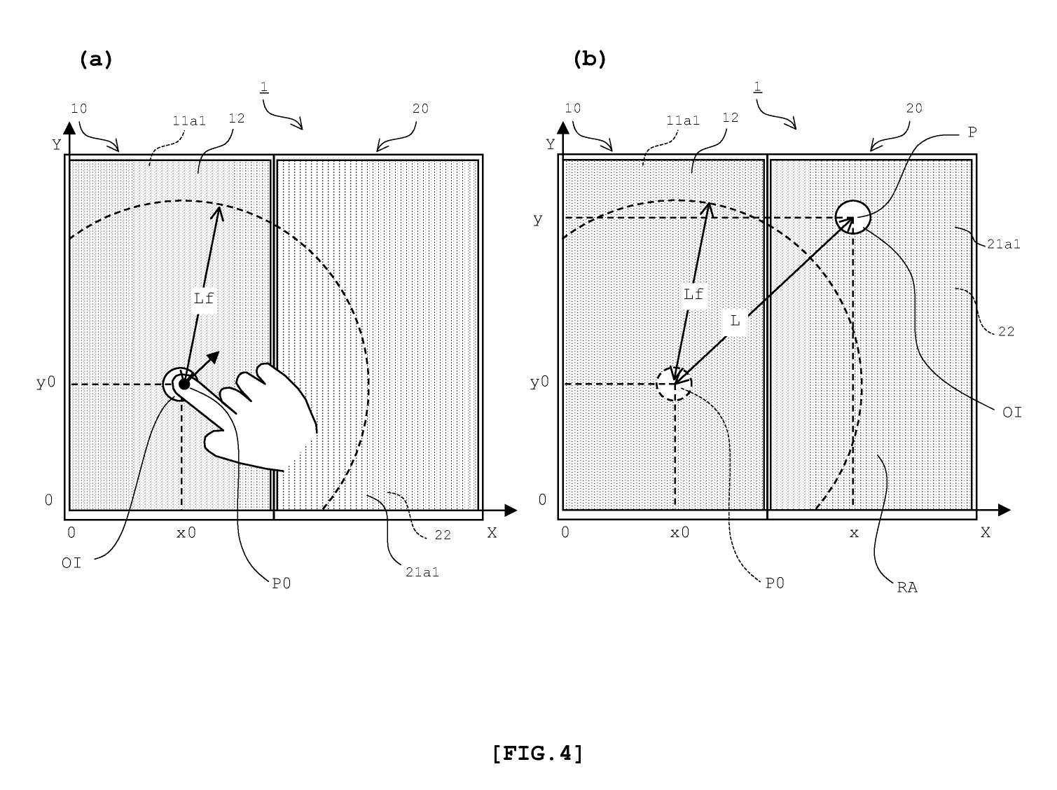

The cancel screen includes the object image OI. On the cancel screen shown in FIG. 4(a), one object image OI is arranged at a predefined starting position P0. As shown in FIG. 4(b), on the cancel screen, the display coordinate system of the first display surface 11a1 and the display coordinate system of the second display surface 21a1 are common.

When the user performs such an operation as sliding or flicking, the object image OI is moved on the cancel screen. For example, if the user performs an operation of moving the object image OI from the starting position P0 for more than a predetermined distance of 320 px within predetermined time of 0.2 second, it is determined that flicking was performed. In addition, for example, if the user performs an operation of moving the object image OI from the starting position P0 for more than the predetermined distance of 320 px in length of time which is longer than the predetermined time of 0.2 second, it is determined that sliding was performed.

Specifically, while the user slides his/her finger touching on the object image OI on the display surfaces 11a1 and 21a1 and the touch sensors 12 and 22 outputs a position signal to the CPU 100, a display position P of the object image OI is aligned with an input position of the position signal. As shown in FIG. 4(b), with this, the object image OI is displayed on the input position touched by the user, and the display position P of the object image OI is moved corresponding to movement of the input position of the position signal from the touch sensors 12 and 22. When the finger which touches the object image OI moves from the first display surface 11a1 to the second display surface 21a1, there is time during which no position signal is output to the CPU from any of the touch sensors 12 and 22 from when a position signal from the first touch sensor 12 is no longer output till when a position signal is output from the second touch sensor 22. If this time is below predetermined length of time, it is determined that the operation of moving the object image OI is continuing. On the one hand, if this time exceed the predetermined length of time, it is determined that the finger which touched the object image OI was released, and the object image OI is displayed to return to the starting position P0.

In addition, when the finger which touches the object image OI is released by flicking from the display surfaces 11a1 and 21a1, the travel speed and travel distance C of the object image OI are determined from the travel speed of the input position before the release, based on the information of association of operation amount and travel distance in the memory 200. With this, the object image OI is displayed to move from a display position Pn at the time of release at the determined travel speed for the travel distance C.

In addition, when the key lock is cancelled, the CPU 100 displays an operation screen in place of the cancel screen on the display surfaces 11a1 and 21a1. Alternatively, the operation screen may appear at predetermined time after it is determined that the key lock function is cancelled. The operation screen may be a predefined screen or the screen which the user operates before setting the key lock function.

In addition, when an application of the energy saving function is activated, the CPU 100 turns off the backlights 11b and 21b. For example, elapsed time after there is no longer input signal from the touch sensors 12, 22 and the key input circuit 303 exceeds predetermined length of time, the power saving function is set and the backlights 11b and 21b are turned off. Alternatively, if the hard key 37 to which a process for setting the power saving function is assigned is operated, the power saving function is set and the backlights 11b and 21b are turned off.

On the one hand, if the predetermined hard key 37 or any hard key 37 for cancelling the power saving function is operated, the power saving function is cancelled and the CPU 100 turns on the backlights 11b and 21b.

As the function control section, the CPU 100 sets or cancels the key lock function in accordance with input information from the user or information from a program.

For example, if a process to set the key lock function is assigned to an icon displayed on the display surfaces 11a1 and 21a1 or the hard key 37, the key lock function is set when the user operates the icon or the hard key 37. Specifically, if the power supply key 36 is pressed for more than predetermined length of time, the key lock function is set.

When the key lock function is set and the cancel screen appears, only an input to the object image OI on the cancel screen is received by the touch sensors 12 and 22. Thus, any input other than that to the object image OI is disabled, and a process corresponding to any input other than the operation for cancelling the key lock function is not performed.

In addition, if the backlights 11b and 21b are turned off with the key lock function set, any input other than that for turning on the backlights 11b and 21b is disabled. Thus, if the hard key 37 to which the process for turning on the backlights 11b and 21b is assigned is operated, the process is performed, and the backlights 11b and 21b are turned on. If the backlights 11b and 21b are turned off, since the cancel screen is not displayed, an input to the object image OI on the cancel screen can not be performed.

In addition, if the elapsed time after there is no longer input signal from the touch sensors 12 and 22 and the key input circuit 303 exceeds predetermined length of time, the key lock function is set.

On the one hand, if the user performs an operation of moving the object image OI from the starting position P0 for more than a predetermined distance on the cancel screen, the key lock function is cancelled. An arc represented by the dot lines in FIG. 4(a) and FIG. 4(b) show a position a predetermined distance away from the starting position P0 of the object image OI. In addition, in a display area which combines the first display surface 11a1 and the second display surface 21a1, an area which is away from the starting position P0 for more than a predetermined distance is referred to as a cancel area RA.

For example, if the user slides his/her finger which touches the object image OI from the starting position P0, a display position P of the object image OI moves corresponding to the input position, and a distance L between the moved display position P and the starting position P0 is determined. As shown in FIG. 4(b), since the display coordinate system of the first display surface 11a1 is common to the second display surface 21a1, the distance L between the starting position P0 (x0, y0) of the object image OI and the display position P(x, y) of the object image OI is expressed by {(x−x0)²+(y−y0)²}^{1/2}. If the distance L is larger than the predetermined distance Lf: 320 px, it is determined that the object image OI has been moved to the cancel area RA. This cancels the key lock function.

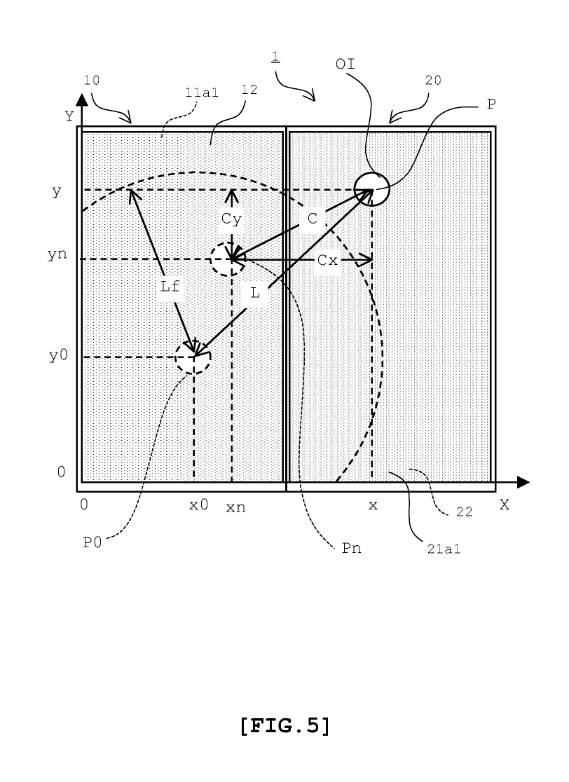

In addition, if the user releases his/her finger which touches the object image OI by flicking, the travel distance C of the object image OI is determined from the travel speed of an input position before the release based on the information on association of operation amount and travel distance. The flicking moves the display position P of the object image OI from the display position Pn at the time of release for the travel distance C. As shown in FIG. 5, since the display coordinate system of the first display surface 11a1 is common to the display coordinate system of the second display surface 21a1, the display position P(x,y) by the flicking is determined from the display position Pn (xn, yn) at the time of release and the travel distance C. Thus, if a distance in the x axis direction of the travel distance C is Cx and a distance in y axis direction is Cy, the display position P of the object image OI which was moved by flicking is represented by (xn+Cx, yn+Cy). The distance L between the display position P and the starting position P0 is expressed by {(xn+Cx−x0)²+(yn+Cy−y0)²}^{1/2}. Thus, if the distance L exceed the predetermined distance Lf, it is determined that the user performed the operation of moving the object image OI to the cancel area RA. This cancels the key lock function.

In this manner, when the key lock function is cancelled, any input other than the operation of cancelling the key lock function may be received and processing corresponding to the input is performed.

When the finger is released by flicking, the travel distance C and the distance L of the object image OI is determined. If the distance L reaches the predetermined distance Lf, the key lock function is cancelled and the cancel screen is switched to the operation screen. Thus, although the operation of moving the object image OI to the cancel area RA by flicking is performed, switching to the operation screen may take place before the display position P of the object image OI reaches the cancel area RA if time to switch from the cancel screen to the operation screen is shorter than time for the object image OI to move to the cancel area RA. Thus, if the operation of moving the display position P of the object image OI to the cancel area RA by flicking is performed, actual movement of the object image OI to the cancel area RA may not be displayed.

### Procedure for Processing First Embodiment

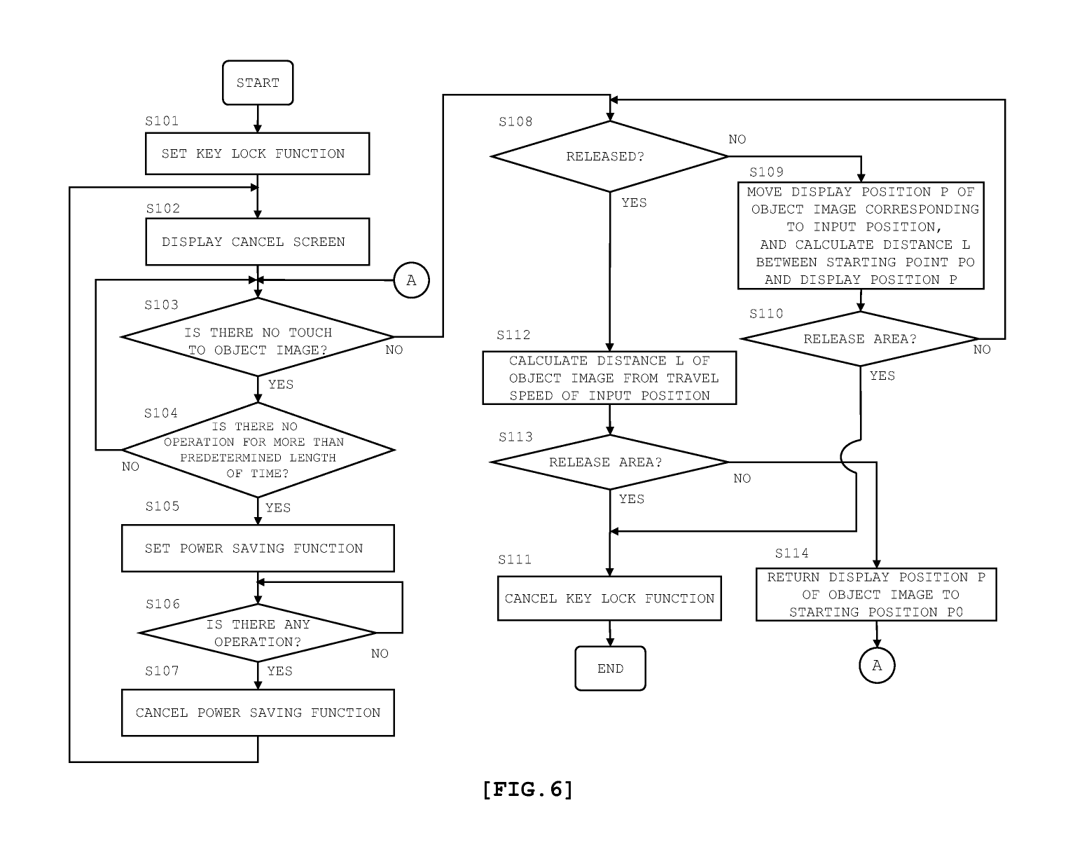

FIG. 4(a) is a diagram in which the cancel screen in which the object image OI is arranged at the starting position P0 is displayed on the display surfaces 11a1 and 21a1. FIG. 4(b) is a diagram in which the cancel screen in which the object image OI is moved from the starting position P0 to the display position P is displayed on the display surfaces 11a1 and 21a1. FIG. 5 is a diagram in which the cancel screen in which the object image OI is moved from the display position Pn at the time of release to the display position P is displayed on the display surfaces 11a1 and 21a1. FIG. 6 is a flow chart showing a procedure for processing to cancel the key lock function when an operation of moving the display position P of the object image OI to the cancel area RA by flicking or sliding is performed.

If no operation is performed on the display surfaces 11a1 and 21a1 or the hard key 37 for predetermined length of time, the key lock function is set (S101).

When the key lock function is set, the cancel screen is displayed on the first and second display surfaces 11a1 and 21a1 (S102). The object image OI on the cancel screen is arranged at the starting position P0.

It is monitored whether an operation on the object image OI was performed (S103). If a position signal from the first touch sensor 12 is not output to the CPU 100 or if an input position of a position signal does not match the starting position P0 even if the position signal is output, it is determined that the user has not touched the object image OI (S103: YES).

Thus, if the condition in which the position signal from the first touch sensor 12 does not match the starting position P0 continues for more than predetermined length of time after the cancel screen is displayed, it is determined that the predetermined length of the elapsed time with the object image OI remaining untouched (S104: YES). This sets the power saving function and turns off the display surfaces 11a1 and 21a1 (S105). An operation on the display surface 11a1 and 21a1 is disabled while the display surfaces 11a1 and 21a1 are turned off.

When the hard key 37 is pressed, it is determined that an operation is performed by the user (S106: YES), the power saving function is cancelled, and the cancel screen is displayed on the display surfaces 11a1 and 21a1 (S102). Since the key lock function is not cancelled although the cancel screen is displayed on the display surfaces 11a1 and 21a1, an input to the object image OI is enabled, while an input to any display area other than the object image OI remains disabled.

When the input position of the position signal from the first touch sensor 12 matches the starting position P0, it is determined that the user touched the object image OI (S103: NO).

It is monitored whether the finger which touched the object image OI was released from the first display surface 11a1 (S108).

If the finger is not released (S108: NO), the finger is sliding on the first display surface 11a1. Thus, not only the display position P of the object image OI moves according to the input position but also the distance L between the starting position P0 and the display position P is calculated (S109).

The distance L between the starting position P0 and the display position P is compared with the predetermined distance Lf, and it is monitored whether the operation of moving the object image OI to the cancel area RA was performed (S110). When the distance L exceeds the predetermined distance Lf, it is determined that the display position P of the object image OI was moved to the cancel area RA (S110: YES). This cancels the key lock function and displays the operation screen on the display surfaces 11a1 and 21a1 (S111).

When the distance L is below the predetermined distance Lf, the display position P of the object image OI has not reached the cancel area RA (S110: NO). Thus, the object image OI continues to be moved corresponding to the input position unless the finger which touches the object image OI is released (S109). In addition, the distance L is determined, and it is monitored whether the distance L reaches the predetermined distance Lf (S110).

On the one hand, when the user flicks the finger touching the object image OI, it is determined that the finger was released from the first display surface 11a1 (S108: YES). Based on the information of association of operation amount and travel distance, the travel speed and the travel distance C of the object image OI after the release is determined from the travel speed of the input position before the release. Then, the display position P of the object image OI is moved at the determined travel speed. In addition, the display position P and the distance L after the movement by flicking are determined from the display position Pn at the time of release and the travel distance C (S112).

If the distance L is larger than the predetermined distance Lf when the display position P of the object image OI was moved by flicking from the display position Pn at the time of release by the travel distance C, it is determined that the operation of moving the display position P of the object image OI to the cancel area RA was performed (S113: YES), and the key lock function is cancelled (S111).

If the display position P of the object image OI does not reach the cancel area RA (S113: NO), the display position P of the object image OI returns to the starting position P0 (S114). Then, the process returns to S103 and it is monitored again whether the object image OI is touched (S103).

As described above, according to the embodiment, the key lock function is cancelled by the user touching the starting position P0 of the object image OI, flicking or sliding the display surface with the touching finger, and moving the object image OI to the cancel area RA. Since cancellation of the key lock function is determined through such a series of actions by the user, any case in which the user's inadvertent input cancels the key lock function, resulting in a malfunction can be prevented.

In addition, according to the embodiment, since the cancel screen is displayed on the two display surfaces 11a1 and 21a1, a sufficient distance can be kept between the starting position P0 and the cancel area RA, as compared with the case in which the cancel screen is displayed on one display surface. Accordingly, in order to cancel the key lock function, the user has to move the object image OI for a long distance. Hence, it is easier to exclude any input unintended by the user, and a malfunction is further prevented. In addition, even if the distance between the starting position P0 and the cancel area RA is set longer, the cancel area RA may be provided not only in a longitudinal direction of the display surfaces 11a1 and 21a1, but also in a direction perpendicular to the longitudinal direction. Thus, a direction in which the object image OI is moved is not limited, resulting in excellent operability.

In addition, in order to achieve such functional effect, the mobile terminal device includes a first display section, a second display section, a first detection section which detects an input to the first display section, a second detection section which detects an input to the second display section, a display control section which controls the first display section and the second display section, and a function control section which controls setting and cancelling of a key lock function which disables the input. The display control section performs control for making a display coordinate system in the first display section and a display coordinate system in the second display section continue, displays on the first display section and the second display section a cancel screen for cancelling the key lock function, and moves a position of an object image contained in the cancel screen corresponding to an input detected by either one of the first detection section and the second detection section. The function control section sets a cancel area for the key lock function in the first display section and the second display section on the cancel screen, and cancels the key lock function when an input to move the position of the object image to the cancel area is detected by either one of the first detection section and the second detection section.

### Second Embodiment

In the first embodiment, when the operation of moving the display position P of the object image OI to the cancel area RA by flicking or sliding is performed, the key lock function is cancelled. In contrast, in a second embodiment, if the display position P of the object image OI which is moved by sliding is in the cancel area RA at the time of release, the key lock function is cancelled.

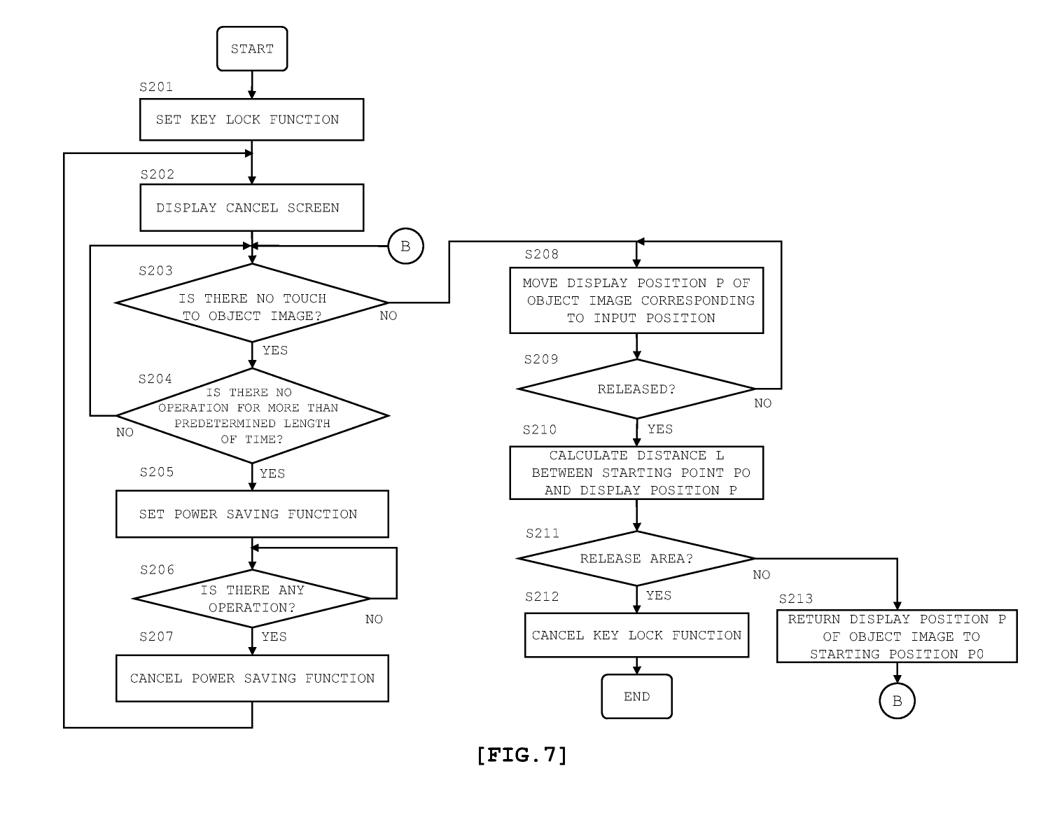

FIG. 7 is a flowchart showing a procedure for processing to cancel the key lock function by the display position P of the object image OI at the time of release being in the cancel area RA. Since processes in S201 to S207 in FIG. 7 are respectively similar to processes in S101 to S107 in FIG. 6, a description is omitted.

When the object image OI is touched by the user (S203: NO), the display position P of the object image OI is then moved following movement of the input position (S208).

It is monitored whether the user releases his/her finger touching the object image OI (S209). When the first and second touch sensors 12 and 22 no longer detect an input position, it is determined that the finger was released from the display surfaces 11a1 and 21a1 (S209: YES).

The input position immediately before the release is read from the memory 200 and the distance between the input position and the starting position P0 is calculated. Since the input position corresponds to the display position P of the object image OI, the distance between the input position and the starting position P0 is determined as a distance L between the starting position P0 and the display position P. Accordingly, the distance L is determined from the distance between the input position and the starting position P0 (S210).

When the determined distance L exceeds the predetermined distance Lf, the display position P of the object image OI at the time of release is within the cancel area RA (S211: YES). This cancels the key lock function (S212). When the key lock function is cancelled, the operation screen appears on the display surfaces 11a1 and 21a1, and the cellular phone 1 becomes usable.

While the finger touching the object image OI is not released (S209: NO), the object image OI is moved corresponding to the input position of the user (S208).

In addition, when the distance L of the display position P of the object image OI which was determined at the time of release is shorter than the predetermined distance Lf and the display position P of the object image OI is not in the cancel area RA at the time of release (S211: NO), the display position P of the object image OI is returned to the starting position P0 (S213). Then, the process returns to S203 where it is monitored again whether the object image OI is touched (S203).

As described above, according to the embodiment, the key lock function is cancelled if the display position P of the object image OI is moved to the cancel area RA when the user releases his/her finger touching the object image OI from the display surfaces 11a1 and 21a1. Specifically, when the user's finger is released from the display surfaces 11a1 and 21a2 in the cancel area RA, the key lock function is cancelled. Thus, since cancellation of the key lock function is determined from the display position P of the object image OI at the time of release, a case in which the key lock function is cancelled by simply the display position P reaching the cancel area RA accidentally is eliminated. Thus, the key lock function is cancelled following the user's intention, therefore a malfunction can be prevented.

### Third Embodiment

In the second embodiment, the key lock function was cancelled when the display position P of the object image OI moved by sliding at the time of release was in the cancel area RA. In contrast, in a third embodiment, the key lock function is cancelled if the display position P of the object image OI moved by sliding is in the cancel area RA during predetermined length of time.

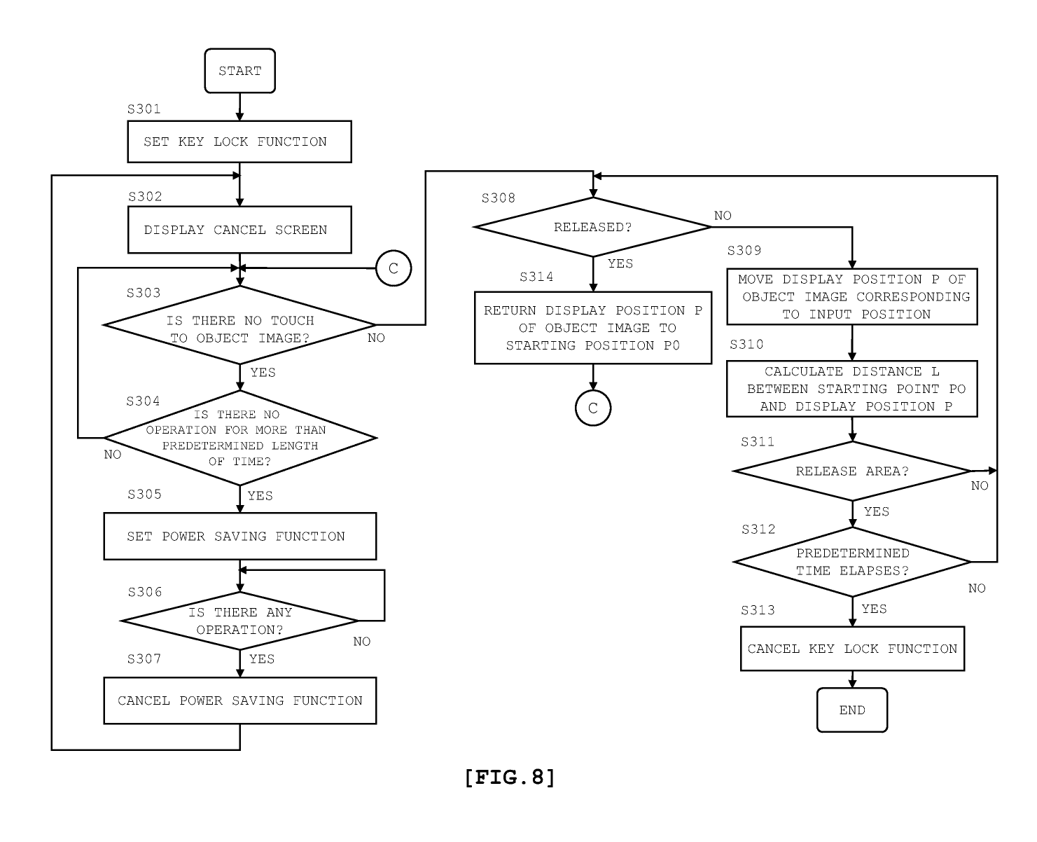

FIG. 8 is a flow chart showing a procedure for processing to cancel the key lock function by the display position P of the object image OI being in the cancel area RA during predetermined length of time. Since processes in S301 to S307 in FIG. 8 are respectively similar to processes in S101 to S107 in FIG. 6, a description is omitted.

The object image OI is moved corresponding to the input position (S309) after the user touches the object image OI with his/her finger (S303: NO), and until the user releases his/her finger touching the object image OI from the display surfaces 11a1 and 21a1 (S308: NO).

In addition, as the display position P of the object image OI moves, the distance L between the destination display position P and the starting position P0 is calculated (S310).

The distance L from the starting position P0 to the display position P is compared with the predetermined distance Lf (S311). If the distance L is less than the predetermined distance Lf, the object image OI is not in the cancel area RA (S311: NO). Thus, while the finger touching the object image OI has not released (S308: NO), the object image OI is moved corresponding to movement of the input position (S309). Then, the distance L of the object image OI is calculated (S310), and it is monitored whether the distance L reaches the predetermined distance Lf (S311).

If the distance L exceeds the predetermined distance LF, it is determined that the display position P of the object image OI was moved to the cancel area RA (S311: YES).

Elapsed time after the object image OI reaches the cancel area RA is measured. If the measured time does not exceed the predetermined length of time (S312: NO), it is monitored whether the display position P of the object image OI is in the cancel area RA (S308, S309, S310, S311: YES). While the object image OI is in the cancel area RA, measurement of the elapsed time continues. When the measured time exceeds the predetermined length f time (S312: YES), it is determined that the object image OI is in the cancel area RA for more than the predetermined length of time, and the key lock function is cancelled (S313).

If the object image OI does not reach the cancel area RA, or the finger touching the object image OI is released before the predetermined length of time elapses even if the object image OI reaches the cancel area RA (S308: YES), the display position P of the object image OI is returned to the starting point P0 (S314), and processing returns to S303.

As described above, according to the embodiment, the key lock function is cancelled by the user moving the object image OI to the cancel area RA and then keeping the object image OI so that it does not go out of the cancel area RA. Thus, since cancellation of the key lock function is determined based on the operation of maintaining a state in which the object image OI exists in the cancel area RA, a case in which the key lock function is cancelled by the display position P accidentally reaching the cancel area RA is eliminated, and a malfunction is prevented.

### Fourth Embodiment

In the third embodiment, the key lock function is cancelled if the display position P of the object image OI continues to be in the cancel area RA for the predetermined length of time. In contrast, in a fourth embodiment, the key lock function is cancelled if the display position P of the object image OI continues to be at a certain position in the cancel area RA for predetermined length of time. The certain position includes not only a position where the object image OI is stopping but also an area within a predetermined distance from the position where it is stopping.

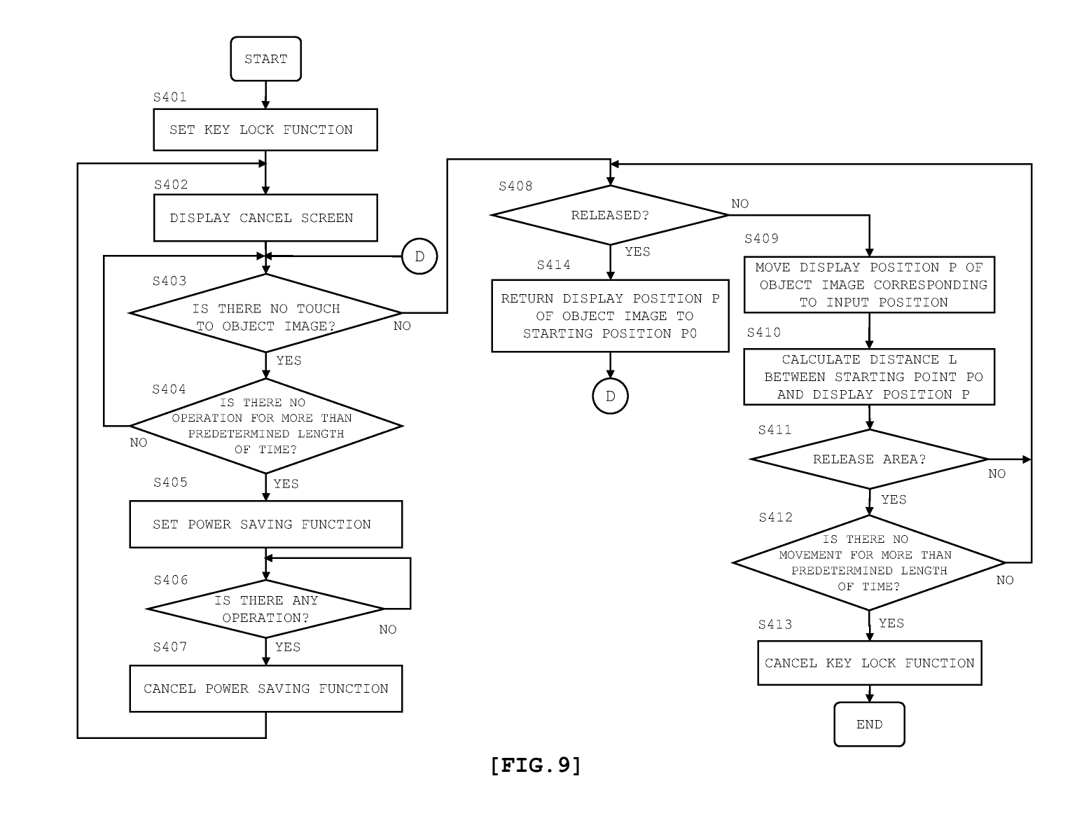

FIG. 8 is a flow chart showing a procedure for processing to cancel the key lock function by the display position P of the object image OI not moving from the certain position in the cancel area RA for the predetermined length of time. Since processes in S401 to S407 in FIG. 9 are respectively similar to processes in S101 to S107 in FIG. 6, a description is omitted.

When the display position P of the object image OI reaches the cancel area RA (S311: YES), it is monitored whether the finger touching the object image OI is released and whether the object image OI exists in the cancel area RA (S408, S411). If the finger touches the object image OI and the object image OI exists in the cancel area RA (S408: NO, S411: YES), the display position P of the object image OI is monitored (S412). When the display position P of the object image OI is moved in the cancel area RA, measurement of length of time starts. When the display position P changes again, the measurement is started again after the measured time is reset. When the object image OI stops moving, the measurement of length of time continues. When the measured time exceeds elapsed time, it is determined that the object image OI has not moved more than the predetermined length of time (S412: YES). This cancels the key lock function (S413).

As described above, according to the embodiment, the key lock function is cancelled by the user moving the object image OI to the cancel area RA and then stopping the object image OI at the same position in the cancel area RA for more than the predetermined length of time. Thus, a case in which the key lock function is cancelled by simply the display position P accidentally reaching the cancel area RA is eliminated, and a malfunction is prevented.

### Other Embodiments

Although the embodiment has been described above, the present invention shall not be limited at all by the above embodiments, and various changes can also be made to the embodiments in addition to the above.

For example, although the starting position P0 is at the predefined position in the above embodiment, it is not limited to this. For example, if the object image OI is moved by sliding and then flicked, a position where it is flicked is set as the starting position. In addition, if the object image OI is moved by sliding, a first position from which the object image OI continuously moves without stopping is set as the starting position.

In addition, in the above embodiment, although the circular object image OI is displayed on the cancel screen of the key lock function, the cancel screen is not limited to this.

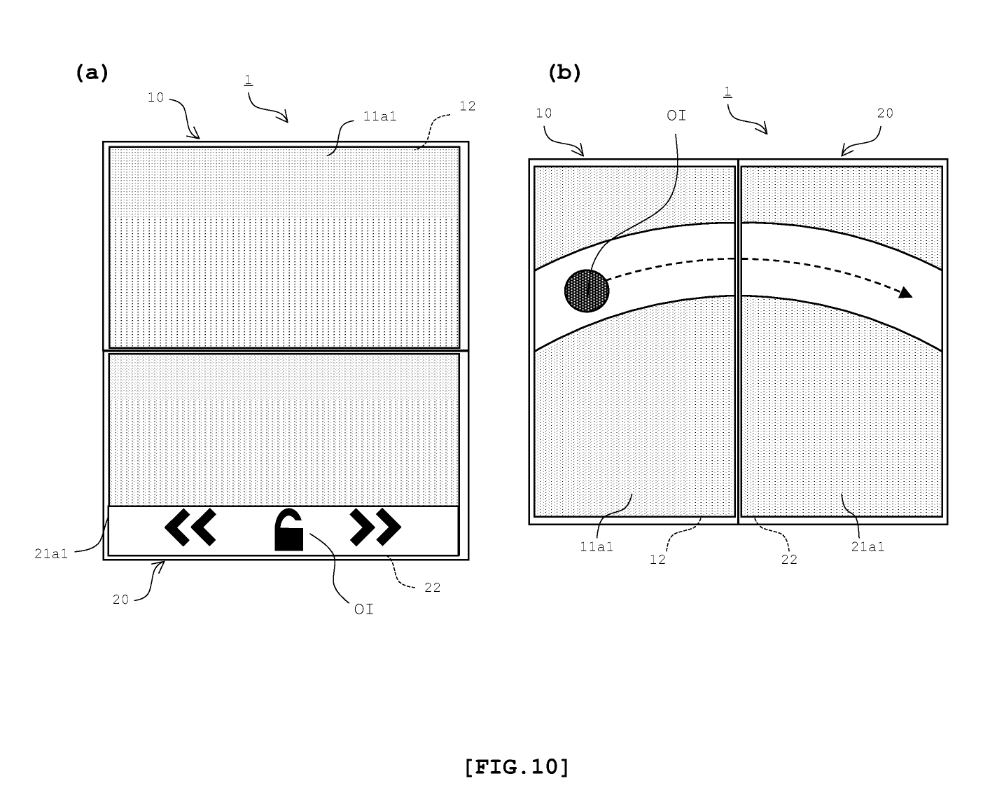

For example, on the cancel screen as shown in FIG. 10(a), a rectangular object image OI containing a key and arrows is displayed at the starting position at an end of the first display surface 11a1. If the object image OI is touched and moved for more than a predetermined distance, the key lock function is cancelled.

In addition, on the cancel screen as shown in FIG. 10(b), a circular object image OI is displayed on an arc-shaped path. If the object image OI is touched and moved along the path for more than the predetermined distance, the key lock function is cancelled.

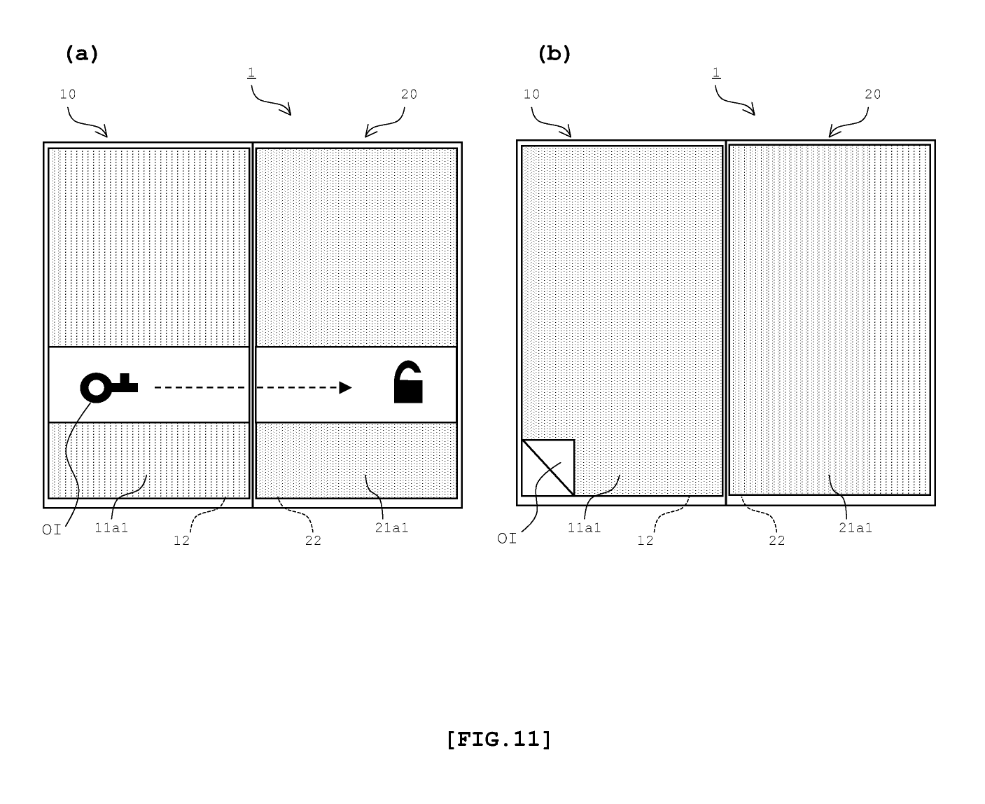

In addition, on the cancel screen as shown in FIG. 11(a), a key-shaped object image OI and a lock image are displayed on a rectangular path, and the key-shaped object image OI and the lock image are spaced for a predetermined distance. When the key-shaped object image OI is touched and moved along the path to a position of the lock image, the key lock function is cancelled.

In addition, on the cancel screen as shown in FIG. 11(b), a triangle object image OI as if the corner of the screen is folded back is displayed. When the object image OI is touched and moved for more than the predetermined distance, the key lock function is cancelled. In this example, as the object image OI moves, the folded back part is displayed so that it is extended.

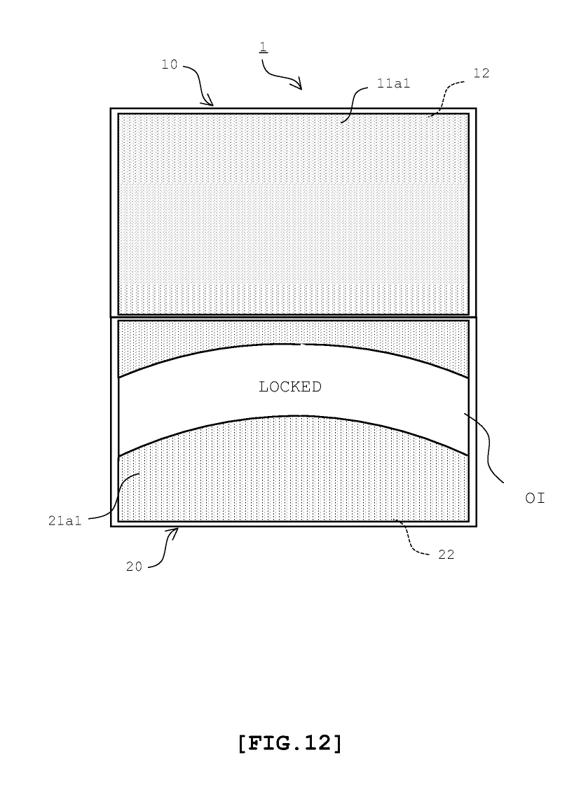

In addition, on the cancel screen as shown in FIG. 12, an arc-shaped object image OI showing predetermined characters such as locked is displayed. When the object image OI is touched and moved for more than the predetermined distance, the key lock function is cancelled.

In addition, in the above embodiment, if movement of the object image OI is stopped and a subsequent operation of moving the object image OI has remained undone for more than the predetermined length of time with the object image OI still touched, the power saving function may also be set after the display position P of the object image OI is stored in the memory 200. If the power saving function is set, the first and second backlights 11b and 21b are turned off. While the first and second backlights 11b and 21b are turned off, the key lock function is performed and an input to the first and second display surfaces 11a1 and 21a1 is set to disabled. Then, when a predetermined hard key 37 for cancelling the power saving function is operated, the power saving function is cancelled, and the first and second backlights 11b and 21b are turned on. Then, the display position P of the object image OI before the power saving function is performed is read from the memory 200, and the cancel screen in which the object image OI is arranged at the display position P is displayed on the first and second display surfaces 11a1 and 12a1. Then, the distance L between the display position P read from the memory 200 and the starting position P0 is calculated, and the distance L is compared with the predetermined distance Lf. If the distance L exceeds the predetermined distance Lf, the key lock function is cancelled and the cancel screen is switched to the operation screen. On the one hand, if the distance L is less than the predetermined distance Lf, the object image OI moves from the display position P to the starting position P0 on the cancel screen with the key lock function maintained. With this, if the power saving function and the like is performed during the operation of cancelling the key lock function, there is no need to redo the operation and thus the embodiment has excellent convenience, since contents of the operation is maintained after the power saving function is cancelled.

Furthermore, as described above, the object image OI may be arranged not at the display position P read from the memory 200 but at the starting position P0 when the power saving function is cancelled.

In addition, in the above embodiment, if the display position P of the object image OI does not reach the cancel area RA, the display position P of the object image OI is returned to the starting position P0. Then, a comment for prompting the user to move the object image OI faster may be displayed on the display surfaces 11a1 and 21a1.

Furthermore, in the above embodiment, although the backlights 11b and 21b are turned off when the power saving function is set, brightness of the backlights 11b and 21b may be reduced. In this case, if the power saving function is cancelled, brightness of the backlights 11b and 21b increases.

In addition, in the above embodiment, setting and cancelling of the key lock function can be switched by switching of a state of the cellular phone 1. For example, if the cellular phone 1 is switched from a closed state to an open state while the key lock function is set, the key lock function is cancelled. Thus, since the key lock function is cancelled simply by the switching operation of the cellular phone 1, there is no need for the operation for cancelling the key lock function and operability is excellent.

Furthermore, in the above embodiment, there are some cases in which notification of an incoming call is performed or an alarm function is activated while the operation of moving the object image OI is performed on the cancel screen. In such a case, in place of the cancel screen, a screen for coping with an incoming call or an alarm is displayed on the first and second display surfaces 11a1 and 21a1, and an input to the screens is enabled. Thus, if there is a need to cope immediately, in such a case of an incoming call or an alarm, a screen for the function appears and operation for the function becomes possible, resulting in excellent convenience.

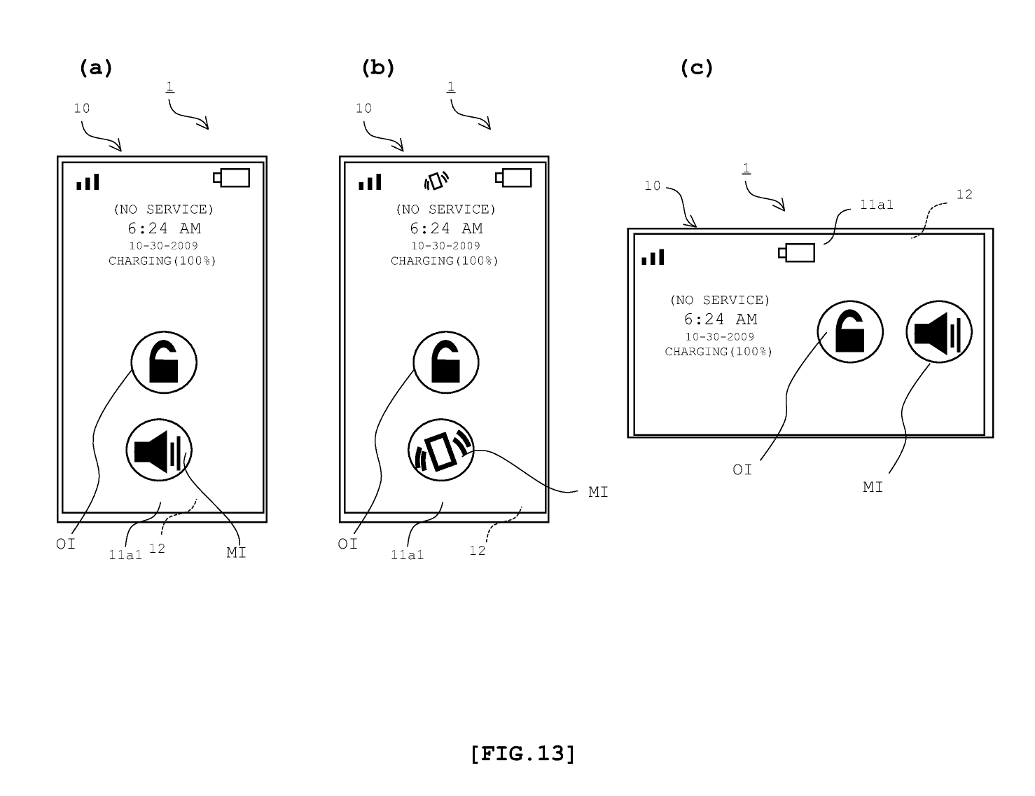

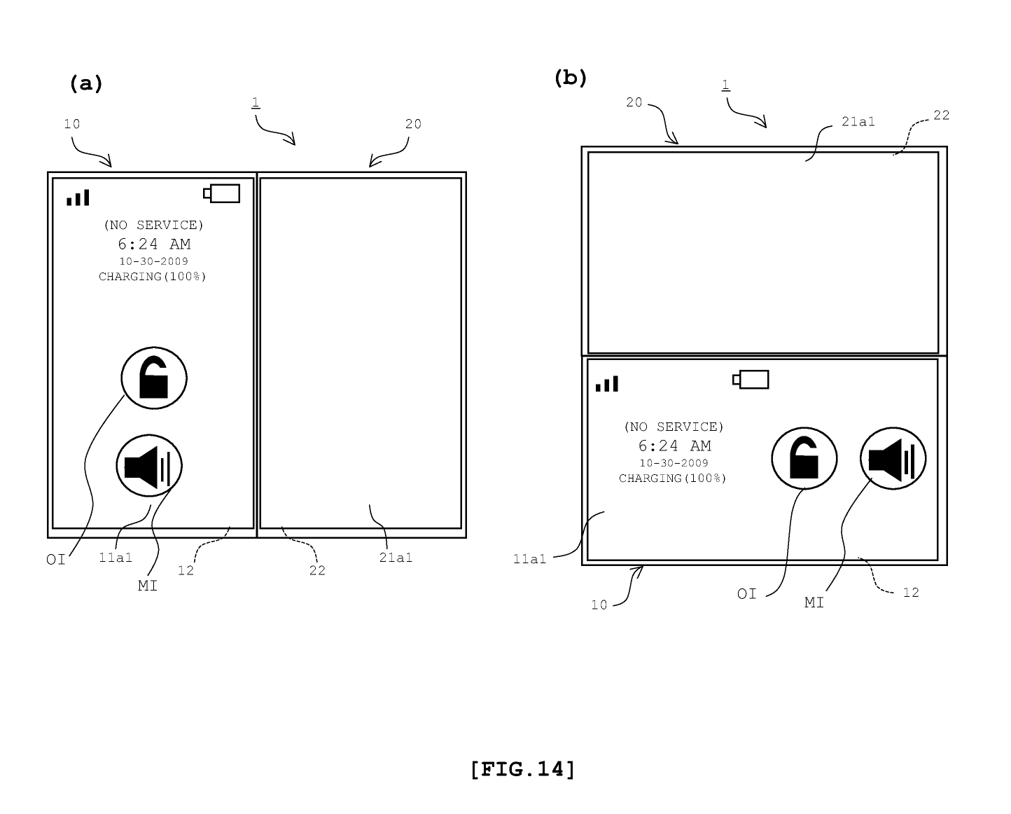

In addition, the above embodiment may have a configuration that manner mode can be switched on the cancel screen. As shown in FIG. 13(a) to FIG. 13(c), and FIG. 14(a) and FIG. 14(b), a switching image MI for setting or cancelling the manner mode is displayed on the cancel screen. The switching image MI corresponds to other object image for switching a notifying means, and is different from the object image OI for cancelling the key lock function. The notifying means includes notification by sound and notification by vibration. If the manner mode is set, notification is done through vibration. If the manner mode is cancelled, notification is done through sound.

Specifically, as shown in FIG. 13(a) and FIG. 13(b), the cancel screen is displayed on the first display surface 11a1 in a closed state. On the cancel screen, the manner mode switching image MI is displayed in addition to the object image OI. If the manner mode is not set, as shown in FIG. 13(a), the switching image MI represents that sound is output from the speaker 38 as notifying means for an incoming call or an alarm and the like. On the one hand, if the manner mode is set, as shown in FIG. 13(b), the switching image MI represents that vibration is generated as notifying means for an incoming call or an alarm.

Similar to cancellation of the key lock function, a switching area is set in an area which is away from the starting position of the switching image MI for more than a predetermined distance. When the switching image MI is moved to the switching area by operation of the user, the manner mode is set or cancelled and the notifying means is switched. For example, if the switching image MI as shown in FIG. 13(a) is moved to the switching area in a state in which the manner mode is not set, the manner mode is set and the screen shown in FIG. 13(b) appears in place of that shown in FIG. 13 (a). From switching of the switching image MI in this manner, it is shown that notification by sound has switched to notification by vibration. To the contrary, when the switching image MI shown in FIG. 13(b) is moved to the switching area, the manner mode is cancelled. In this case, although the manner mode is cancelled, the key lock function is still maintained, and thus the cancel screen shown in FIG. 13(a) remains displayed on the display surfaces 11a1 and 21a1. The key lock function may be cancelled at the same time when the manner mode is cancelled, by the switching image MI as shown in FIG. 13(b) being moved to the switching area. With this, an operation screen appears in place of the cancel screen on the display surfaces 11a1 and 21a1.

As shown in FIG. 13(c), if an orientation of the cellular phone 1 is changed from portrait to landscape, an arrangement or a display direction of the object image OI, the switching image MI and the like on the cancel screen is switched. In addition, as shown in FIG. 14(a) and FIG. 14(b), also in an open state, the cancel screen is displayed on the first and second display surface 11a1 and 21a1, and the object image OI and the switching image MI are arranged on the first display surface 11a1. In the open state, however, the object image OI and the switching image MI may be arranged on the second display surface 21a1.

In addition, while the switching image MI is operated, the object image OI may be displayed in translucently. To the contrary, while the object image OI is operated, the switching image MI may be displayed translucently. Such control of display can remind the user of which image of either one of the switching image MI and object image OI is operated.

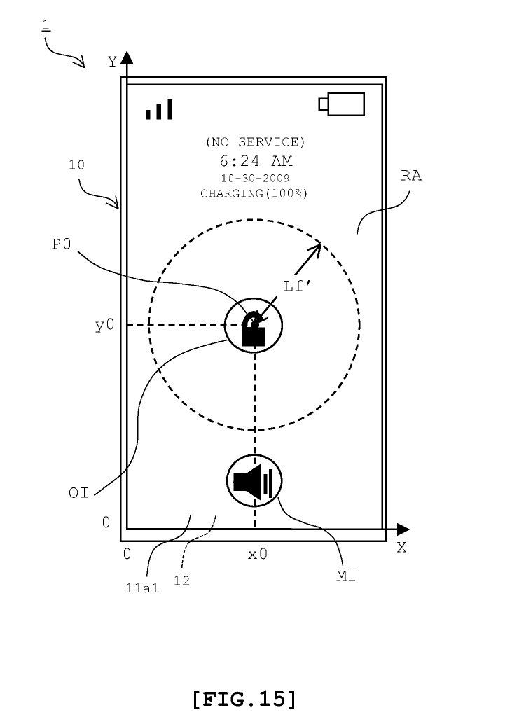

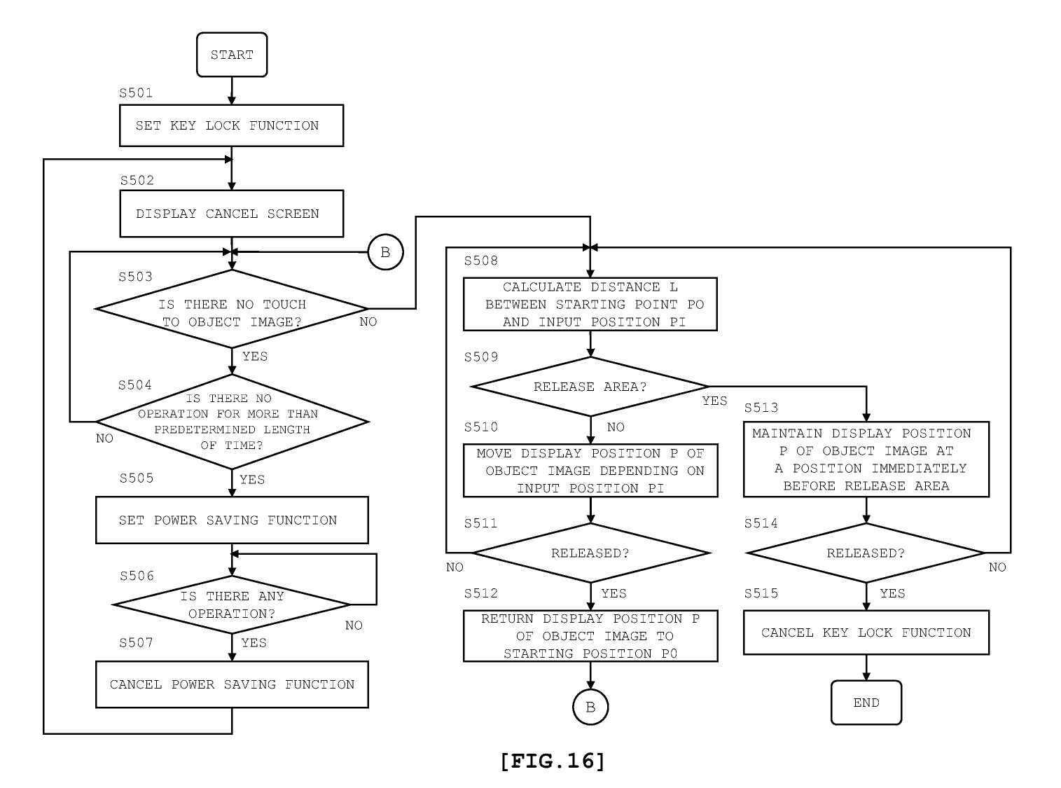

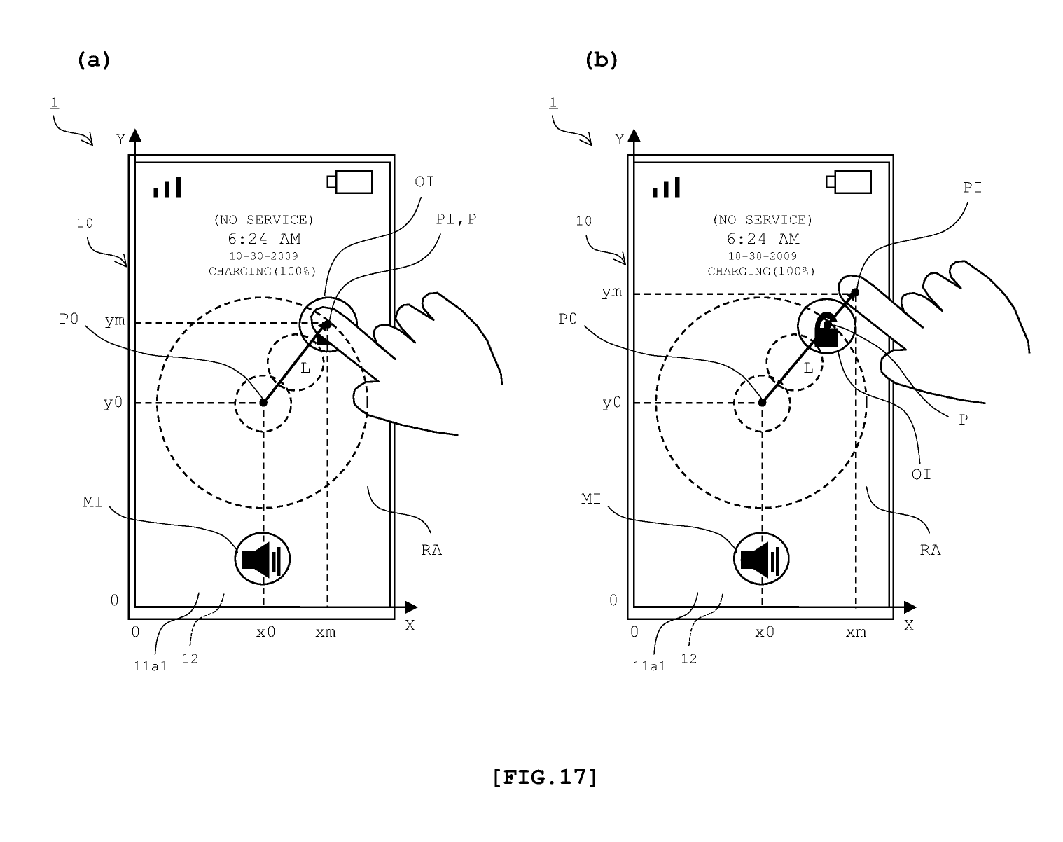

FIG. 15, FIG. 16, FIG. 17(a) and FIG. 17(b) are diagrams for describing a configuration example for cancelling the key lock function in a state in which the cellular phone 1 is closed and only the first display surface 11a1 is exposed to the eternal.

FIG. 15 is a diagram in which the cancel screen is displayed on the first display surface 11a1. FIG. 16 is a flow chart showing a procedure for processing to cancel the key lock function. FIG. 17(a) is a diagram showing a state in which the finger touching the object image OI is moved to a position in front of the cancel area RA. FIG. 17(b) is a diagram showing a state in which the finger touching the object image OI is moved into the cancel area RA.

As shown in FIG. 15, in the configuration example, an area outside of a virtual circle (shown by the broken line) having the starting position P0 (a position where the object image OI is displayed before being moved) as a center and the predetermined distance Lf′ as a radius is set as the cancel area RA. Since the predetermined distance Lf′ is set shorter than a distance between the starting position P0 and right and left ends of the first display surface 11a1, the cancel area RA exists in all peripheries of the object image OI displayed at the starting position P0. Hence, the user can move his/her finger touching the object image OI to the cancel area RA by moving the finger in any direction.

Functions of the switching image MI arranged on the cancel screen are same as functions of the switching image MI shown in FIG. 13(a) or FIG. 14(b), and thus a description is omitted.

The CPU 100 performs the process of cancelling the key lock function, in accordance with the processing procedure as shown in FIG. 16.

If the user has not performed an operation on the first display surface 11a1 for predetermined length of time and the key lock function is set (S501), the cancel screen is displayed on the first display surface 11a1 (S502). When the cancel screen is displayed, an individual display coordinate system is read from the memory 200, and control by the CPU 100 is carried out based on the individual display coordinate system.

It is monitored whether the object image OI is touched (S503). When certain length of time elapses with the object image OI untouched (S504: YES), the power saving function is set and the first display surface 11a1 is turned off (S505). If the user performs the cancel operation (S506: YES), the power saving function is cancelled (S507).

When the user cancels the key lock function, he/she touches the object image OI with his/her finger and moves the touching finger to a desired direction.

If it is detected that the object image OI is touched (S503: NO), the distance L between the starting position P0 and the position touched by the finger, in other words, the input position PI is calculated (S508). The distance L between the starting position P0 (x0, y0) and the input position PI (xm, ym) is represented by {(xm−x0)²+(ym−y0)²}^{1/2}.

From a comparison of the calculated distance L with the predetermined distance Lf′, it is determined whether the input position PI has reached the cancel area RA, specifically, whether the finger has moved to the cancel area RA (S509).

If the input position PI has not reached the cancel area RA (S509: NO), the display position P of the object image OI is moved following the movement of the input position PI (S510). As shown in FIG. 17(a), the object image OI moves following the moved finger.

If the finger is released from the first display surface 11a1 before the input position PI reaches the cancel area RA (S511: YES), the display position P of the object image OI is returned to the starting position P0 (S512). Then, processing returns to S503, and it is again monitored whether the object image OI is touched (S503).

When the user continues to move his/her finger, the finger reaches the cancel area RA. In step S509, if it is determined that the input position PI has reached the cancel area RA (S509: YES), the display position P of the object image OI is not moved following movement of the input position PI, and the object image OI is maintained at a position immediately before reaching the cancel area RA in the travel direction of the finger (input position PI) (S513). As shown in FIG. 17(b), although the user's finger has been moved into the cancel area RA, the object image OI remains at a position immediately before reaching the cancel area RA.

Thus, if the finger is released from the first display surface 11a1 with the user's finger in the cancel area RA (S514: YES), the lock function is cancelled (S515).

In this manner, in the configuration example, the cancel area RA is provided in all of peripheries of the object image OI so that a direction in which the object image OI is moved to cancel the key lock function is not limited to one direction. Hence, the user can cancel the key lock function by moving the object image OI in any direction, and convenience to the user increases.

Furthermore, in the configuration example, even if the finger has been moved to the cancel area RA, the object image OI remains at a position in front of the cancel area RA. Thus the user can be aware that the finger has reached the cancel area because the object image OI no longer follows the finger's movement. This can prevent the user from performing unnecessary movement operation.

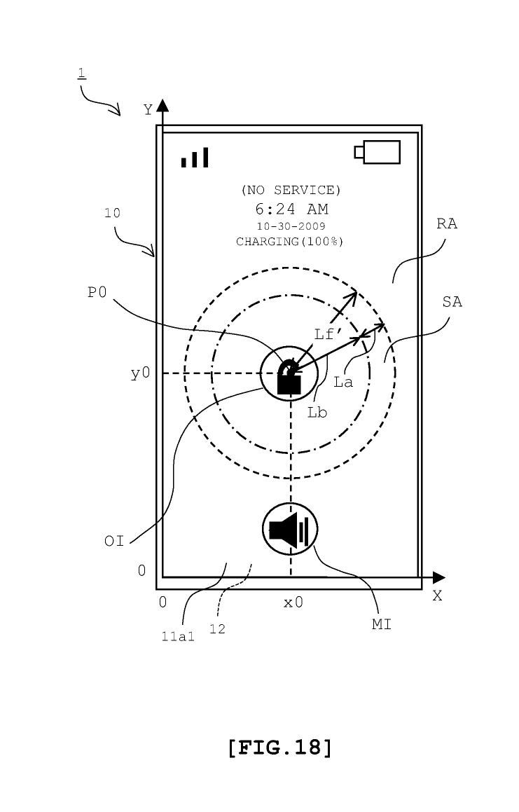

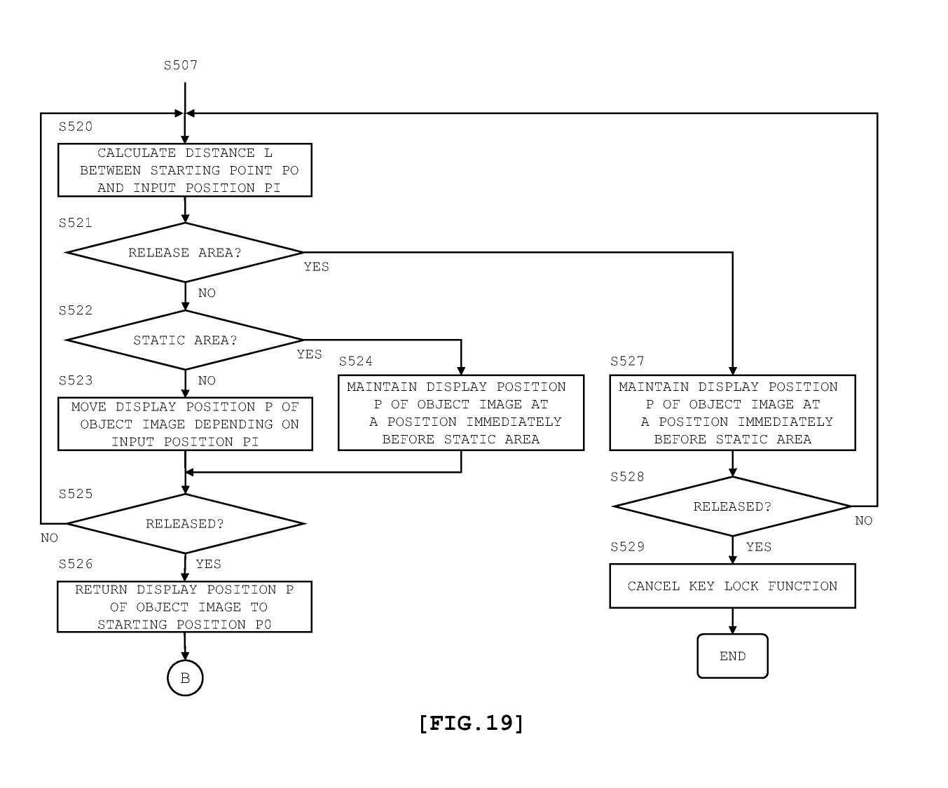

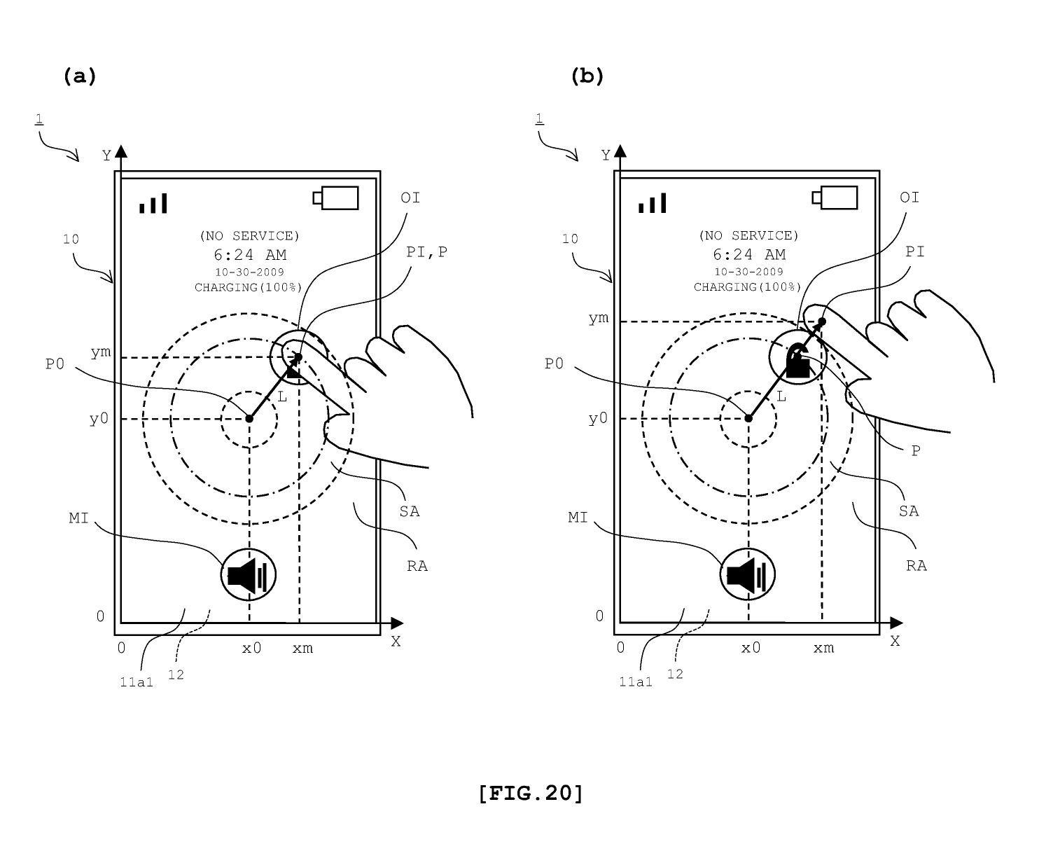

FIG. 18, FIG. 19, FIG. 20(a) and FIG. 20(b) are diagrams which describe modification examples of the configuration shown in FIG. 15 and FIG. 17(b). FIG. 18 is a diagram in which the cancel screen is displayed on the first display surface 11a1. FIG. 19 is a flow chart showing a procedure for processing to cancel the key lock function. FIG. 20(a) is a diagram showing a state in which the finger touching the object image OI has moved to the position in front of a static area SA. FIG. 17(b) is a diagram showing a state in which the finger touching the object image OI has been moved into the cancel area RA.

In the modification example, as shown in FIG. 18, an area between a virtual circle (shown by the broken line) zoning the cancel area RA and a virtual circle (shown by the chain line) having a radius of a distance Lb which is shorter than the predetermined distance Lf′ by predetermined length La is set as the static area SA. The static area SA is an area where the object image OI does not move following the finger's movement.

In the modification example, as shown in FIG. 19, processes in steps S508 to S515 in the process of cancelling the key lock in the above configuration example are replaced by processes insteps S520 to S529. Since the processes insteps S501 to S507 are same as the above configuration example, they are not shown in FIG. 19 and a description is omitted.

With reference to FIG. 19, when it is detected that the object image OI was touched (S503: NO), the distance L between the starting position P0 and the input position PI is calculated (S520). From a comparison of the calculated distance L with the predetermined distance Lf′, it is determined whether the input position PI has reached the cancel area RA (S521).

If the input position PI has not reached the cancel area RA (S521: NO), it is determined from a comparison of the calculated distance L with the distance Lb whether the input position PI reached the static area SA, specifically, whether the finger moved to the static area SA (S522). If the input position PI does not reach the static area SA (S522: NO), the display position P of the object image OI is moved following movement of the input position PI (S523). As shown in FIG. 20(a), the object image OI moves following the moved finger.

If the finger is moved to the static area SA, it is determined that the input position PI reached the static area SA (S522: YES). In this case, the display position P of the object image OI is not moved following the movement of the input position PI, and the object image OI is maintained at a position immediately before reaching the static area SA in the travel direction of the finger (input position PI) (S524).

If the finger is released from the first display surface 11a1 before the input position PI reaches the cancel area RA, specifically in a state in which the input position PI is in the static area SA or at a position in front of the static area SA (S525: YES), the display position P of the object image OI is returned to the starting position P0 (S526). Then, processing returns to S503, and it is monitored again whether the object image OI was touched.

When the user's finger reaches the cancel area RA beyond the static area SA, it is determined in step S521 that the input position PI reached the cancel area RA (S521: YES). The display position P of the object image OI is continuously maintained at the position immediately before reaching the static area RA (S527). As shown in FIG. 20(b), although the user's finger has been moved into the cancel area RA, the object image OI remains at a position immediately before reaching the static area SA, specifically, at a front position which is away by the predetermined distance La from the cancel area RA.

Thus, when the finger is released from the first display surface 11a1 (S528: YES) with the user's finger in the cancel area RA, the lock function is cancelled (S529).

In the modification example, when the finger is moved to a position which is shorter by predetermined length La from the cancel area RA, the object image OI remains at that position. Thus, when the finger reaches the cancel area RA, the finger is deviated from a position immediately above the object image OI. Thus, since the user can easily confirm that the object image OI has come to rest as soon as the finger reaches the cancel area RA, unnecessary movement operation can be further prevented.

In the above configuration example and the above modification example, the predetermined distance Lf′ is set to a distance which is shorter than the distance between the starting position P0 and the right and left ends on the first display surface 11a1. However, the predetermined distance Lf, may be set to a distance which is longer than the distance between the starting position P0 and the right and left ends of the first display surface 11a1. In this case, a part of the cancel area RA can no longer be provided in the right and left direction of the cancel screen. Since a direction in which the object image OI is moved to cancel the key lock function is not limited to one direction, however, convenience to the user increases.

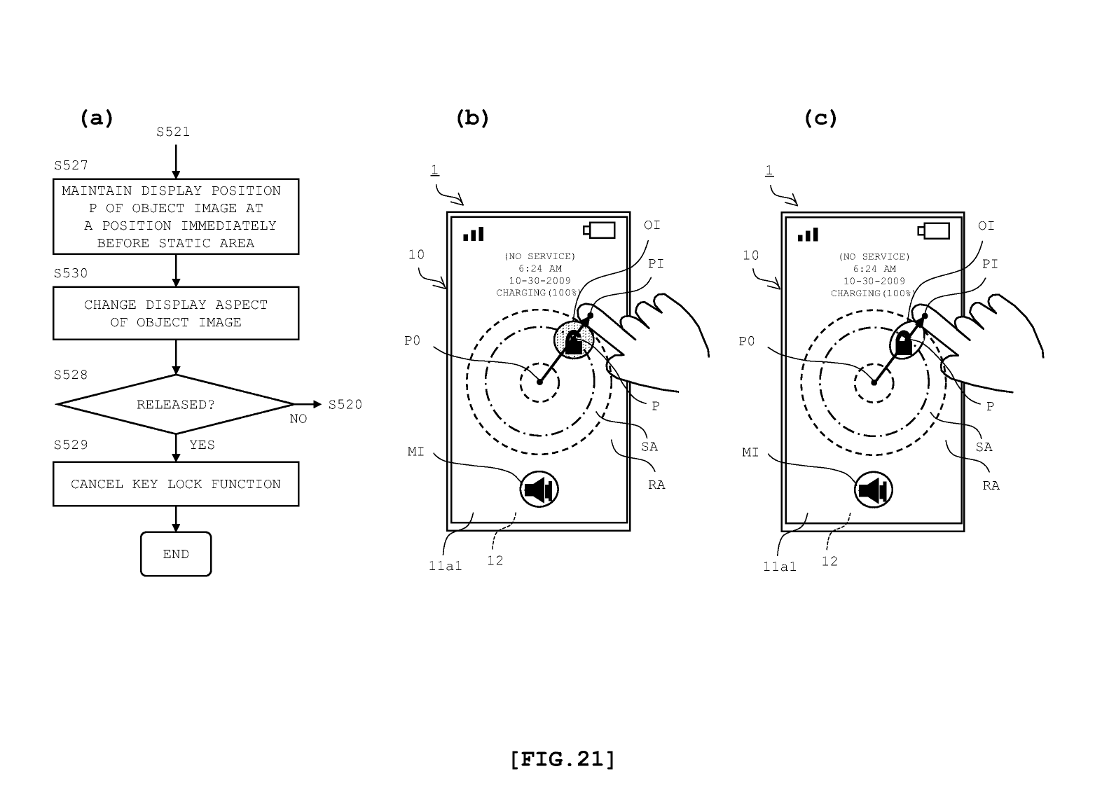

The process of cancelling the key lock function in the above modification example can be further changed as shown in FIG. 21(a). In a further modification example, when the user's finger reaches the cancel area RA (S521: YES), not only the display position P of the object image OI is continuously maintained at the position immediately before reaching the static area RA by the CPU 100 (S527), but also a display aspect of the object image OI is changed (S530). For example, as shown in FIG. 21(b), a color of the object image OI is changed. Alternatively, as shown in FIG. 21(c), a shape of the object image OI is changed. In the example of FIG. 21(c), the round object image OI is changed to an elliptical shape which is long in the travel direction of the finger. However, the object image OI may be changed to other shape such as a quadrangular shape. Furthermore, a change in the display aspect is not limited to a change in the color or the shape and the like, and brightness of the object image OI may be changed, for example. With such a configuration, the user can be aware more clearly that the key lock can be cancelled.

The above configuration examples and modification examples are not limited to the cellular phone provided with two touch panels but can also be applied to a cellular phone provided with one touch panel (a display and a touch sensor).

Furthermore, in the above embodiments, although two touch panels are provided in the cellular phone 1, three or more touch panels can be provided.

In addition, in the above embodiments, although the cellular phone 1 is used, a mobile terminal device such as a PDA or a mobile game device may also be used.

Besides, various types of changes may be made to the embodiment of the present invention, as appropriate, as far as they fall within a scope of technical idea as shown in the Claims. For example, a part or all of the above embodiments can be combined.

### REFERENCE SIGNS LIST

1 Cellular phone
11 First display
12 First touch sensor
21 Second display
22 Second touch sensor
100 CPU
200 Memory
OI Object image
MI Switching image

1. A mobile terminal device comprising:
a display section with a display surface on which an image is displayed;
a detection section which detects a touch input to the display surface;
a display control section which controls the display section; and
a function control section which controls cancellation of a key lock function that disables a predetermined touch input to the display surface, wherein
the display control section
displays on the display surface a cancel screen for cancelling the key lock function, and
moves an object image depending on movement of a touch position when the object image contained in the cancel screen is touched by a user and the touch position is moved,
the function control section
sets a cancel area of the key lock function on the cancel screen so that a direction in which the object image is moved to cancel the key lock function is not limited to one direction, and
cancels the key lock function when the touch position to the object image is moved to the cancel area.

2. The mobile terminal device according to claim 1, wherein, an outside area of an arc located away from a starting position of the object image is set to the cancel area on the cancel screen.

3. The mobile terminal device according to claim 1, wherein an area set at a position away from the starting position of the object image is set to the cancel area on the cancel screen.

4. The mobile terminal device according to claim 1, wherein the display control section keeps the object image at a position in front of the cancel area in a travel direction of the touch position, in the process in which the touch position to the object image is moved to the cancel area.

5. The mobile terminal device according to claim 4, wherein the display control section keeps the object image at the front position which is away from the cancel area by a predetermined distance.

6. The mobile terminal device according to claim 5, wherein the display control section changes a display aspect of the object image when the touch position to the object image is moved to the cancel area.

7. The mobile terminal device according to claim 1, further comprising:
a notifying means control section which switches notifying means, wherein the cancel screen contains other object image which is different from the object image,
the display control section
moves the other object image depending on a touch input detected by the detection section,
the function control section
sets a switching area of the notifying means in the cancel screen, and
switches the notifying means when the detection section detects a touch input of moving the other object image to the switching area.

8. The mobile terminal device according to claim 7, wherein the notifying means includes notification with sound and notification with vibration, and
the notifying means control section switches the notification with sound and the notification with vibration when the other object image is moved to the switching area.

9. A storage medium holding a computer program which provides a computer of a mobile terminal device including a display section with a display surface on which an image is displayed and a detection section which detects a touch input to the display surface, with capabilities of
displaying on the display surface a cancel screen for cancelling a key lock function which disables a predetermined touch input to the display surface, and moving an object image depending on movement of a touch position when the object image contained in the cancel screen is touched by a user and the touch position is moved; and
setting a cancel area of the key lock function on the cancel screen so that a direction in which the object image is moved to cancel the key lock function is not limited to one direction, and cancelling the key lock function when the touch position to the object image is moved to the cancel area.

10. A lock cancellation method of a mobile terminal device including a display section with a display surface on which an image is displayed and a detection section which detects a touch input to the display surface, wherein the lock cancellation method includes steps of
displaying on the display surface a cancel screen for cancelling a key lock function which disables a predetermined touch input to the display surface;
moving an object image depending on movement of a touch position when the object image contained in the cancel screen is touched by a user and the touch position is moved; and
cancelling the key lock function when the touch position to the object image is moved to the cancel area which is set on the cancel screen so that a direction in which the object image is moved to cancel the key lock function is not limited to one direction.
